(19) United States
(12) Patent Application Publication
(10) Pub. No.: US 2026/0057414 A1
(43) Pub. Date: Feb. 26, 2026

(54) Intermediate Server for Enhanced Privacy, Security, and Efficient User-Company Data Transactions Using Multidimensional Vectors

(71) Applicant: Noboru NISHIMURA, Tokyo (JP)

(72) Inventor: Noboru NISHIMURA, Tokyo (JP)

(21) Appl. No.: 18/812,806

(22) Filed: Aug. 22, 2024

(51) Int. Cl. G06Q 30/0251; G06F 16/22; G06F 21/62

(52) U.S. Cl. CPC G06Q 30/0271; G06F 16/2237; G06F 16/2264; G06F 21/6254

(57) ABSTRACT

Communication equipment and system architecture to facilitate the continuous collection, analysis, and secure transfer of user profile data. An intermediate server connects portable terminals to merchant and service provider servers for improved privacy, security, and optimized data transactions using multidimensional vectors. Portable terminal and server enhancements allow for continuous data collection and communication, enabling the regular generation of multidimensional vectors from current user data. User profile data originate from portable terminals, resulting in data that is regularly and almost continuously changing. The system and method enable the continuous collection and regular updating of user profile data, enhancing efficiency across all applications and systems reliant on such data. Portable terminals are equipped with sensors and processing capabilities, allowing for integrated data collection. This system enables the collection, analysis, and synthesis of user data to produce multidimensional vectors representing various aspects of user behavior, preferences, and activities. These vectors have broad applications, including personalized recommendations, contextual awareness, and targeted advertising. Portable terminals facilitate transactions between users and companies without disclosing personal information until a contract is established. An intermediary server, represented by the management server, facilitates user-profile-based interactions between users and service providers without revealing personal information on the service site. The service provider sends to the intermediate management server Market Persona profile information—which could be in the form of natural language Market Persona information or in the form of a multidimensional Market Persona vector with appropriate dimension tags and provider ID.

### TECHNICAL FIELD

In existing systems, behavioral data is commonly collected and processed by service provider devices, introducing potential vulnerabilities to user privacy and data security. The present invention seeks to address these concerns by enabling the generation of multidimensional vectors directly on portable terminals (user devices), thereby minimizing exposure to external threats. The present disclosure relates to portable terminal hardware that facilitates the generation of multidimensional vectors based on user data. More specifically, data collection and communication terminals with hardware for generating multidimensional vectors based on user data and a service-providing system including the same.

### BACKGROUND

“User profile information:” is a term that encompasses both behavioral data and demographic data. This term refers to a comprehensive set of data points that describe an individual's characteristics, behaviors, preferences, and demographic attributes. It includes information about how users interact with products, services, or platforms (behavioral data) as well as their age, gender, location, income level, education, and other demographic factors. User profile information is valuable for businesses and organizations to tailor their offerings, personalize user experiences, and target their marketing efforts effectively. Behavioral and demographic data collection currently occurs on service provider devices, exemplified by platforms such as online retailers suggesting “Top picks for you” based on user activity. This practice involves aggregating and analyzing user interactions, preferences, and behaviors to generate personalized recommendations and experiences. While seemingly beneficial for enhancing user engagement and satisfaction, this approach presents inherent risks to user privacy and data security.

Firstly, when behavioral and demographic data are collected and processed on service provider devices, users relinquish control over their personal information. Data is often stored and analyzed on remote servers controlled by the service provider, creating opportunities for unauthorized access, data breaches, and misuse. This centralized model introduces vulnerabilities that may expose sensitive user data to malicious actors, leading to privacy violations and potential harm to individuals.

Moreover, the sheer volume and granularity of behavioral data collected by service providers pose significant privacy concerns. Detailed insights into user preferences, thoughts, and behaviors are meticulously analyzed to generate personalized recommendations and targeted advertisements. While ostensibly aimed at enhancing user experience, the extensive profiling of individuals raises ethical and regulatory questions regarding data ownership, consent, and transparency.

Furthermore, the lack of transparency and accountability in the collection and use of behavioral and demographic data exacerbates privacy concerns. Users are often unaware of the extent to which their activities are monitored, analyzed, and utilized by service providers. This opacity undermines user autonomy and undermines trust in the platforms and services they engage with.

Moreover, in known commercial applications, the user must provide very specific personal information, including his/her name, mail address, date of birth, and history of debt to other companies, for example, to the system server that provides services. Even though the user need not directly provide such specific personal information to the consumer finance company, should the user provide such specific personal information to the system, the user is still concerned that his/her personal information may possibly be not treated properly. Likewise, users are reluctant to embrace personalized and context-aware services using the terminal if their personal information may be compromised. Therefore, the construction of a more secure service system is desired.

With their widespread use in commerce, there is a growing need for improved security measures to protect personal information. For instance, consider systems where users input personal information and loan request conditions into their portable terminals, which then transmit this data to a system server. In response, consumer finance companies bid for financing based on these conditions. There is a need for systems where the user's personal information is only shared with the system, ensuring its protection. Enhancing portable terminals to safeguard user privacy is essential in scenarios like these, where sensitive information is transmitted and stored.

In summary, the current state of the art, characterized by the collection of personal and behavioral data on service provider devices, poses significant risks to user privacy and data security. Centralized storage and analysis of sensitive information, coupled with a lack of transparency and control, undermine user autonomy and expose individuals to potential harm. As such, there is a pressing need for alternative approaches that prioritize user privacy, data security, and ethical data practices in the digital ecosystem.

### SUMMARY

Embodiments include an intermediate server design for connecting portable terminals to merchant and service provider servers for improved privacy, security, and optimized data transactions using multidimensional vectors.

The system and method disclosed herein provide for the secure generation of multidimensional vectors (including manifold functions or any other similar mathematical expressions such as “functions in multidimensional spaces”; hereinafter, the same) directly on portable terminal devices. As used herein, the term “portable terminal device” encompasses a wide variety of devices, e.g., user device, portable terminals, mobile terminals, wearable electronic devices, and smartphones so long as they have the requisite functionality. The multidimensional vectors encapsulate sensitive information relating to personal data and user preferences, thoughts, and behaviors, thereby necessitating robust security measures. A dimension tag is associated with each dimension of the multidimensional vector. A “dimension tag” can be a label or identifier for each dimension in a vector. Tagging dimensions helps in understanding and interpreting the data, making it easier to know what each component of the vector represents. In AI and multidimensional vectors, dimensions are individual features or attributes of the data. Dimension tags are labels that help identify and interpret these features.

By generating multidimensional vectors on the portable terminal device itself, the disclosed system and method mitigate the risk associated with external data processing entities, such as management servers or cloud computing systems. This approach ensures the protection of user privacy while allowing for the responsible collection and transmission of behavioral data.

Generating multidimensional vectors as described herein is a critical process intricately tied to sensitive user information, including preferences, thoughts, and behaviors. Due to the inherent security risks associated with external data processing, these vectors are exclusively generated within the portable terminal device. This approach safeguards user privacy and mitigates potential security breaches.

In a system where numerous discrete users are equipped with portable terminals, there is a need for a management server that can receive and store the multidimensional vectors and tags in association with USERIDS.

Given that users consistently carry their personal terminal devices (such as smartphones and wearable devices), these personal terminal devices are well-situated to collect behavioral data firsthand. This not only ensures the integrity and confidentiality of the data but also enhances user control over their personal information. Consequently, the generation of multidimensional vectors within the portable terminal device emerges as a logical and secure choice, affirming a commitment to protecting user privacy and data security.

The disclosed system comprises a plurality of portable terminal devices that may be different in many respects, but all are equipped with sensors and data processing capabilities. These devices are uniquely positioned to gather and analyze user behavior in real-time, thereby dynamically generating multidimensional vectors that encapsulate a comprehensive understanding of user preferences, thoughts, and behaviors.

In operation, the portable terminal device collects data of what a user is viewing on the internet via screen capturing and AI recognition functions, capturing information about the user's interests, favorites, and propensity to behave. The portable terminal device also collects raw data from various sensors, including but not limited to gyroscopes, accelerometers, and biometric sensors. These data are then processed locally on the device using algorithms designed to extract relevant behavioral insights. Through this process, multidimensional vectors are generated, representing the intricate interplay of user preferences, thoughts, and behaviors. In addition, dimension tags are associated with each dimension.

In one embodiment, the generation of multidimensional vectors occurs exclusively on the portable terminal device, ensuring that sensitive data remains under the user's control at all times. This approach mitigates the risk of data breaches and unauthorized access commonly associated with external data processing entities. The multidimensional vectors and dimension tags together with an USER ID are passed to an intermediary (management) server as discussed herein. The intermediary (management) server may be used between the users and service providers as described herein. The intermediate server may generate multidimensional vectors and tensors representing the target user profile presumed to match with the profile of the product/service to be offered by the service providers, based on data received from the users and service providers. Maintaining standard formats for data used to generate vectors is more challenging than interpreting multidimensional vectors and tags received from users. Thus, it is preferred to provide an application for each type of portable terminal device that includes code segments to generate multidimensional vectors and dimension tags that are suitable for sending to the intermediate management server as described herein. The frequency at which updated multidimensional user profile vectors (together with USERID and dimension tags) are sent from the portable terminals can be at certain intervals (every 12 hours, every day, etc.), or whenever a change occurs in the multidimensional vector, or when a change in the multidimensional vector is greater than a specified threshold. In every case, the multidimensional vector received by the management server is up to date.

In the enhanced system described, each portable terminal device collects data, preprocesses it, extracts features, and constructs a multidimensional vector. The device also tags each dimension of the vector and transmits the vector, tags, and user ID to a common management server. The server receives the data (vector, tags, and user ID), stores them, and manages them for multiple users. This architecture enables efficient, decentralized data collection and processing, with centralized data management and analysis.

The service (product) provider sends to the intermediate management server Market Persona information-which could be in the form of natural language Market Persona information or in the form of a multidimensional Market Persona vector with appropriate dimension tags and provider ID. In this context, Market Persona means a comprehensive description that can include either or both the product/service profile and the detailed profile of the target customer. A Product/Service Profile includes details about the product or service, including its features, benefits, and unique selling points. A Customer Profile is a hypothetical representation of the ideal customer, including demographics, preferences, behaviors, and needs.

The management (intermediate) server itself has a function to convert Market Persona information from a service provider into a multidimensional vector when the product profile or the target profile is input in natural language. In doing so, the management server picks up the tag of each vector-dimension in the multidimensional user profile vector sent from the terminal device which corresponds to each attribute in the service provider Market Persona information and creates a multidimensional Market Persona vector so that the multidimensional Market Persona vector (product profile, service profile and/or target profile) can be inspected on to what extent it is matched with the thus selected multidimensional user profile vector in the same multidimensional vector space, i.e. in one space where each vector consisting of those multidimensional vectors (that of the product profile or of the set of target attributes and that of the user profile) is on the same corresponding dimension. In this enhanced system, service providers can submit target profile requests in plain natural language through a dedicated interface. The management server processes these requests using natural language processing to generate multidimensional Market Persona vectors. These vectors are then compared with existing user profile vectors using a vector matching algorithm to identify matching target users. The system notifies service providers of the identified target users, enabling targeted service delivery based on detailed and dynamically generated user profiles.

The vector generation engines described herein may be implemented by code segments stored in memory of the portable terminal devices and management server. The memory stores code segments executable on the processor to perform the vector generation processes. Furthermore, the disclosed system facilitates the secure transmission of behavioral data from the portable terminal device to management servers or other remote entities. By employing encryption protocols and secure communication channels, the system ensures the confidentiality and integrity of transmitted data, thereby safeguarding user privacy.

The disclosed method encompasses the steps necessary to implement the described system, including data collection, processing, and transmission. Additionally, the method includes provisions for user authentication and authorization, further enhancing security and privacy protections.

The disclosed system and method offer several advantages over existing approaches to data collection and processing:

Enhanced Privacy: By generating multidimensional vectors directly on portable terminal devices, the system minimizes the exposure of sensitive data to external entities, thereby preserving user privacy.

Improved Security: Local data processing reduces the risk of data breaches and unauthorized access, mitigating security concerns associated with external data processing entities.

User Empowerment: By placing control over data generation in the hands of users, the system promotes transparency and accountability, empowering users to make informed decisions about their data.

Efficient Data Transmission: Secure communication protocols ensure the reliable transmission of behavioral data to management servers or other remote entities, facilitating data-driven insights without compromising privacy or security, by which, though, users can keep enjoying internet services to the almost same extent as the existing approaches.

The disclosed system and method represent a significant advancement in the field of data privacy and security, offering a robust framework for the generation and transmission of multidimensional vectors on portable terminal devices. By prioritizing user privacy and security, the system provides a foundation for responsible data collection and processing in the digital age.

Embodiments include an enhanced mobile terminal device and a system for users equipped with the mobile terminal device, a management server and a service provider device. The service-providing system is configured to be used in combination with the mobile terminal device, the management server, and the service-provider device.

An embodiment of the portable terminal unit system comprises components that interact to provide a cohesive user experience. The central processing unit (CPU) serves as the core processing unit, executing instructions stored in memory. The CPU coordinates the operation of various components and executes software applications to perform diverse tasks.

In addition to the CPU, embodiments may include a graphics processing unit (GPU), and a dedicated neural processing unit (NPU) is responsible for processing the raw sensor data and extracting meaningful features. Machine learning algorithms and signal processing techniques may be employed to analyze the data and identify relevant patterns and correlations,

Vector Generation Module: Based on the processed sensor data, the portable terminal generates multidimensional vectors (including the tensor product calculated from them; hereinafter, the same) that encapsulate diverse aspects of the user's behavior, preferences, and context. These vectors may include spatial, temporal, contextual, physiological, and behavioral dimensions, providing a comprehensive representation of the user's digital footprint.

Sensor Array: The portable terminal is equipped with sensors, embodiments of which include but are not limited to accelerometers, gyroscopes, magnetometers, GPS, ambient light sensors, proximity sensors, and biometric sensors (e.g., fingerprint scanners, facial recognition cameras). These sensors capture various aspects of the user's environment, activities, and physiological parameters.

Memory components, including RAM (Random Access Memory) and ROM (Read-Only Memory), store data and instructions necessary for the operation of the portable terminal unit. RAM provides volatile memory for temporary data storage, facilitating quick access by the CPU, while ROM stores essential system software and firmware.

The display component presents visual information to the user, such as graphical user interfaces, images, videos, and text. It interacts with the CPU and memory to render visual content based on user input and application requirements. Screen capture hardware for capturing behavioral data is provided to the portable terminal device as well.

To enable screen capture of behavioral data on the portable terminal device, embodiments include hardware components such as: A display controller that manages the output signals to the display of the portable terminal device. The display controller can be utilized to capture the visual content displayed on the screen. A Graphics Processing Unit (GPU) that handles rendering tasks and can be leveraged to capture graphical data displayed on the screen using framebuffer access. A framebuffer is a portion of memory dedicated to storing pixel data for display. Accessing and copying data from the framebuffer allows for screen capture. By using the screen capture and AI integrated in the portable terminal device, “what” a user is viewing on the internet can be recognized and identified, the information of the “what” being sent to the Vector Generation Module to generate the multidimensional vectors representing it.

While not directly related to capturing on-screen behavior, other components capture behavioral data. A camera sensor to capture user behavior indirectly, such as through facial recognition or eye tracking. A microphone: The microphone can capture audio data, which may be correlated with on-screen behavior.

An input/output (I/O) interface encompasses various mechanisms for user interaction and data exchange. This includes touchscreens, physical buttons, audio input/output interfaces, visual input/output interfaces, and connectivity ports (e.g., USB, headphone jack). User inputs via these interfaces trigger actions within the portable terminal unit's software, while outputs provide feedback to the user.

Power supply components, such as batteries and charging circuits, ensure continuous operation of the portable terminal unit. The battery stores electrical energy, which powers the device's components, while the charging circuit manages the recharging process.

Communication modules enable the portable terminal unit to connect to external networks and devices. This includes cellular, Wi-Fi, Bluetooth, and NFC (Near Field Communication) modules. These modules facilitate data exchange, internet connectivity, and communication with other portable terminal units or peripherals.

The interaction of these components is orchestrated by the operating system and software applications running on the portable terminal unit. User interactions trigger events processed by the CPU, which in turn coordinates the activation of appropriate components to fulfill user requests. For example, when a user launches a messaging application, the CPU initiates processes to display the application interface on the screen, manage user input via the touchscreen or physical buttons, access data from memory, and utilize communication modules to send or receive messages over a network.

Embodiments of the portable terminal units include portable terminal hardware, such as a vector generation module or software engine, to facilitate the creation of multidimensional vectors using user data. This innovation opens doors to a range of personalized and context-aware services, promising a future where our devices adapt seamlessly to our needs and surroundings.

Embodiments may include a User Profile Database: The generated vectors are stored in a user profile database maintained locally on the portable terminal. The database organizes the vectors according to user identity and timestamp, allowing for efficient retrieval and analysis.

Embodiments further include a service provider device managed by a person/company (service provider) who offers services to the user. As discussed below, the service provider device performs the profile marketing and offers advertisements to the user. The management server connects the service provider and the user so that the service provider can offer advertisements to the user. It should be noted that however the user's personal information is not disclosed to the service provider.

The operation of the portable terminal unit can be summarized as follows:

Screen Data Acquisition: The portable terminal collects data of what a user is viewing on the internet via screen capturing and AI recognition functions, capturing information about the user's interests, favorites, and propensity to act in response (behavior).

Sensor Data Acquisition: The portable terminal continuously collects data from its integrated sensors, capturing information about the user's activities, surroundings, and physiological state.

Data Processing and Feature Extraction: The screen data and raw sensor data are processed by the portable terminal's data processing unit, which extracts relevant features and patterns using machine learning algorithms and signal processing techniques.

Vector Generation: Based on the extracted features, the portable terminal generates multidimensional vectors that encode various aspects of the user's behavior and context. These vectors are updated dynamically as new data becomes available.

Storage and Access: The generated vectors are stored in the user profile database, where they can be accessed by authorized applications via application programming interfaces. Developers can utilize the vectors to tailor their services to individual users' preferences and needs.

Embodiments include portable terminals with onboard hardware and computing resources to allow the collection and processing of data on the terminal and passing the result of that data analysis as multidimensional vectors that encode various aspects of the user's behavior and context to protect user information while allowing data analysis.

The portable terminal units herein's ability to generate secure data-rich multidimensional vectors on board and transmit the multidimensional vectors in an encrypted form provides various advantages.

Personalization: The generated multidimensional vectors enable personalized recommendations, content filtering, and user experiences tailored to individual preferences.

Contextual Awareness: By capturing diverse aspects of the user's environment and activities, the system enhances contextual awareness and enables more relevant and timely interactions.

Targeted Advertising: Advertisers can leverage the multidimensional vectors to deliver targeted advertisements based on the user's interests, behaviors, and demographics.

Privacy Preservation: The system employs robust privacy-preserving mechanisms to protect user data, ensuring compliance with privacy regulations and maintaining user trust.

Overall, the proposed system represents a significant advancement in portable terminal technology, empowering users with personalized, context-aware experiences while safeguarding their privacy and data security.

Another practical application of the improved hardware described herein is generating multidimensional user profile vectors for each individual user that contain detailed user profile information stored in multidimensional vectors. Each multidimensional vector comprises a set of vectors, with each vector representing a specific attribute of the user. These attributes encompass various personal, demographic, behavioral, and preference-related factors, including gender, age, address, annual income, assets, web browsing history, hobbies, favorite color, favorite book, favorite film, recent buying behavior, health and exercise conditions, and frequent destinations visited.

By compiling these attribute vectors into a multidimensional vector, a comprehensive representation of the user's profile is obtained. This multidimensional vector encapsulates the multidimensional nature of user preferences, behaviors, and characteristics, enabling a more nuanced understanding of individual users.

When users interact with their mobile terminal devices, data reflecting their behavior (referred to as “behavioral data”) are generated. These data form the basis for calculating the multidimensional vectors of the user profile. Unlike traditional methods relying solely on income and expenditure information, this system incorporates additional data sources such as exercise records, healthcare information, and social networking service (SNS) data to generate the multidimensional vectors. These multidimensional vectors describe various attributes of the user, including demographics and interests.

Vectors representing user attributes, such as web browsing history and buying behavior, can be generated using features like screen-capture and image recognition functions on portable terminal devices. Health and exercise condition vectors, on the other hand, can be derived from sensor data collected by portable terminal devices. The user's web browsing history plays a crucial role in shaping the multidimensional vectors, which evolve over time based on the user's daily activities. Changes to the multidimensional vectors may occur as needed, at predetermined intervals, or regularly.

The multidimensional vectors are generated through advanced analytical techniques such as machine learning algorithms, statistical modeling, and data mining. These algorithms analyze the multidimensional vector to identify patterns, correlations, and trends indicative of user preferences, behaviors, and characteristics.

The multidimensional vectors provide valuable insights into various aspects of user engagement, satisfaction, and relevance across different contexts, such as e-commerce, content recommendation, targeted advertising, and personalized services. By leveraging multidimensional vectors, the disclosed system and method enhance the accuracy, granularity, and effectiveness of the user's profile, thereby improving user experiences and business outcomes.

Advantages of the system and method include enhanced accuracy, granular insights, and adaptive modeling capabilities. The system architecture enables efficient, decentralized data collection and processing, with centralized data management and analysis. Incorporating multiple attributes into a multidimensional vector offers a more accurate and comprehensive representation of user preferences and characteristics. The multidimensional nature of the vector enables granular insights into user behaviors, allowing for more targeted and personalized interactions. Additionally, advanced analytical techniques can adaptively model and update the multidimensional vectors based on evolving user profiles and preferences, ensuring relevance and timeliness in user profiling and recommendation systems. The equipment described herein may be useful in a technique or method that allows transactions between a user (i.e., consumer) and a company to be performed without the personal information of the user being disclosed at all until the user concludes a contract with the company.

An embodiment of an application of the portable terminal device and system includes a communication unit used to access a network, a storage unit that stores various programs as code segments, and a processor that reads a predetermined program from the storage unit and executes the program.

The processor is configured to execute a process of setting a core account within the storage unit of the portable terminal device, The core account is created on the terminal by executing code segments in the processor to create a unit that can receive input for functional units and sensors on the terminal device and generate and multidimensional user profile vector, dimensional tags and associate this with a unique USERID and transmit the same to the management server.

The core account thus provides a process of sending the computed multidimensional vectors to a management server for managing a predetermined service site, and a process of accessing the management server to obtain information on a service to be provided on the basis of the multidimensional vectors.

Another aspect of the invention is an intermediary or management server used to facilitate the transfer of user-specific data between service providers and users while maintaining user anonymity and security. The system employs multidimensional vectors, regularly updated based on user data, to enhance the efficiency of data collection and transfer. Detailed user data are stored as multidimensional vector associated solely with a User ID, which can be changed periodically. These data provide a comprehensive profile of the user linked to the User ID, ensuring anonymity unless access to a table associating the User ID with user contact information is granted.

A service-providing system, according to the present disclosure, may include the aforementioned portable terminal device or other “smart phone” or wearable device, a management (intermediary) server that provides the service site, and a server of a company that uploads to the service site of the management server Market Persona information-which could be in the form of natural language Market Persona information or in the form of a multidimensional Market Persona vector with appropriate dimension tags and provider ID. In this context Market Persona means a comprehensive description that can include either or both the product/service profile and the detailed profile of the target customer. A Product/Service Profile includes details about the product or service, including its features, benefits, and unique selling points. A Customer Profile is a hypothetical representation of the ideal customer, including demographics, preferences, behaviors, and needs.

The intermediate management server need not be configured as a single server device, it may be configured as multiple server devices and the servers may be implemented in the cloud such as AWS, for example. Thus, the “USERID” database and “USER CONTACT INFO” may be stored on different physical devices.

In the system, (i) an intermediate (management) server stores the multidimensional user profile vector, the dimension tag set and user ID generated by the portable terminal of the user and sent to the management server; (ii) at least an external server of the service provider company connects to the management server via a communication line and transmits into the management server the Market Persona information, which includes a Product/Service Profile (details about the product or service, including its features, benefits, and unique selling points) and or a Customer/Target Profile (a hypothetical representation of the ideal customer, including demographics, preferences, behaviors, and needs); (iii) an AI function in the management server automatically generates the multidimensional vector representing the target user profile, picks up (from the user profile already sent from the portable terminal to and stored in the management server) the multidimensional vector of the user profile in the multidimensional vector space comprised with the set of the tagged dimensions equivalent to the set of the attributes of the target user reflecting the profile of the goods/service, finds out the similarity degree of the multidimensional vector representing the user profile from the portable terminal to the multidimensional vector representing the target user profile from the company server, and prepares the management server to send it to the company server via the communication line; (iv) at least a portable terminal of the user generates a multidimensional vector (as a tensor product) of the user profile therein, puts a tag to the Basis of each of the dimensions consisting of the multidimensional vector as a decomposition element of the multidimensional vector therein, generates a user ID at any time therein, and transmits the multidimensional vector of the user profile, the above dimension tag set and the user ID to the management server.

All the tasks thus mentioned are done without disclosing the personal information of the user on the management server or the company server. The service provider with the server of the company determines the contents of services or goods to be provided to the user on the basis of the multidimensional vector matched with the target user profile, and sends an offer to provide the services or goods to the management server.

According to the present disclosure, transactions between a user (i.e., consumer) and a company can be performed securely.

### BRIEF DESCRIPTION OF DRAWINGS

FIG. 1 illustrates an exemplary overall configuration of a service-providing system 1 that manages various services and provides the various services to users according to the present embodiment.

FIG. 2 illustrates an exemplary internal configuration of each of portable terminals 10_1 to 10_n of users 1 and n.

FIG. 3 illustrates an exemplary internal configuration of a management server 20.

FIG. 4 illustrates an exemplary internal configuration of each of servers 30_1 to 30_n of financial service companies 1 to n.

FIG. 5 illustrates the internal configuration of each of servers 40_1 to 40n of online sales companies 1 to n and servers 50_1 to 50_n and 60_1 to 60_n of other services-A-to-X-providing companies 1 to n.

FIG. 6 is a flowchart for illustrating the operation of a core application executed on each of the portable terminals 10_1 to 10_n of the users.

FIG. 7 is a flowchart for illustrating a process executed by the management server 20.

FIG. 8 illustrates an exemplary configuration of a multidimension vectors' similarity degree table 800 of each user that is disclosed to each company on a browse page, which is dedicated to a goods/service-providing company, on a service site.

### DESCRIPTION OF EMBODIMENTS

Embodiments of system and method for secure transfer of user data will now be described. Embodiments include an intermediate server design for connecting portable terminals to merchant and service provider servers for improved privacy, security, and optimized data transactions using multidimensional vectors. The system may include some or all of the hardware components described herein. Various system architectures may be employed to allow the secure collection, analysis and transfer of user profile data. Because the source of user profile data is the user's smart phone, wearable device or other portable terminal, user profile data are regularly, almost continuously, changing. The system and method described herein allows continuous collection of data and updating of user profile data to provide improved efficiency in all applications and systems that rely on user profile data.

This invention provides a system and method facilitating the transfer of user-specific data between service providers and users while maintaining user anonymity and security. The system employs multidimensional vectors, continuously updated based on user data, to enhance the efficiency of data collection and transfer. Detailed user data are stored in the management server as multidimensional vectors associated solely with a User ID, which can be changed periodically. These data provide a comprehensive profile of the user linked to the User ID, ensuring anonymity unless access to a table associating the User ID with user contact information is granted.

The table containing User IDs, user contact information (non-disclosed to service providers), and updated multidimensional vectors associated with the User IDs are securely maintained on the management server. The management server has the capability to update all data in the table.

### Example Table

| | USER CONTACT | Multidimensional Vector |
|---|---|---|
| USERID | INFO | (Tensor Product) |
| 1001 | john@example.com | \|35\|1\|60000\|2\|1\|3\|4\|5 \| |
| 1002 | jane@example.com | \| 28\|2\|45000\|0\|2\|2\|3\|3 \| |
| 1003 | alex@example.com | \| 40\|1\|80000\|3\|0\|4\|5\|2 \| |

In this simplified example, each row corresponds to a different user, displaying their associated USERID, contact information, and multidimensional vector where numerical values are separated by a pipe (|) delimiter.

### Attributes and Tags:

| Vector Value | Tag |
|---|---|
| 35 | Age |
| 1 | Gender |
| 60000 | Annual Income |
| 2 | Number of Cars |
| 1 | Home Ownership |
| 3 | Hobbies |
| 4 | Favorite Color |
| 5 | Exercise Level |

Each numerical value in the multidimensional vector represents an attribute, such as age or annual income, tagged accordingly for clarity.

The above example is a simplified illustration. In actual practice, the system could involve millions of users and thousands of attributes. Moreover, the system could be implemented on multiple physical and/or cloud servers. The core concept lies in combining the User ID with the Multidimensional Vector (the tensor product) to create a detailed user profile without revealing any personally identifiable information. Furthermore, the User ID can be periodically changed to minimize the risk of identifying users. For instance, the User ID may only be known within the system itself and remain undisclosed to the users. In the example given earlier, user 1001 “John” might have a consistent username and different login credentials internally linked to User ID 1001. The system could regularly update the User ID (e.g., monthly, weekly, daily, or per transaction) and associate the new User ID with John's username. Keeping recent User IDs logged may be necessary to complete pending transactions. Additionally, new data are continuously generated as users interact with their portable terminal devices (such as web browsing) and the device's sensors monitor their activities (like health and location tracking). The frequency at which updated multidimensional user profile vectors, USERID and dimension tags are sent from the portable terminals can be at certain intervals (every 12 hours, every day, etc.), or whenever a change occurs in the multidimensional vector, or when a change in the multidimensional vector is greater than a specified threshold. In every case, the multidimensional vector received by the management server is up to date.

### Usage of Data:

In an embodiment, a management server allows two primary uses of the recorded data by the service provider:

a. Profile Marketing for Potential Customer Research:

The service provider can access the management server to generate their goods/service profile vectors or persona vectors, describing their goods/service or a user's persona, respectively. Alternatively, the service provider can generate their goods/service profile vectors or persona vectors in their own system and send them to the management server. In the first case above, the management server automatically generates the goods/service profile vectors or persona vectors in the form of multidimensional vectors, using the AI function integrated in the management server, once the service provider inputs to the management server the description of the goods/service profile or persona in natural language. The management server then matches these vectors with the multidimensional vectors of the user profile, providing the service provider with the data/information of marketability for their goods/service while maintaining user anonymity.

b. Offer of Advertisements to Anonymous Users:

The management server matches these vectors above with the multidimensional vectors of the user profile and returns the number of potential customers to the service provider. Subsequently, the service provider instructs the management server to transmit advertisement data to potential customers based on their User IDs, allowing anonymous receipt of advertisements.

In an embodiment, the service provider sends to the intermediate management server Market Persona information-which would ordinarily be in the form of natural language Market Persona information or alternatively in the form of a multidimensional Market Persona vector with appropriate dimension tags and provider ID. In this context Market Persona means a comprehensive description that can include either or both the product/service profile and the detailed profile of the target customer. A Product/Service Profile includes details about the product or service, including its features, benefits, and unique selling points. A Customer Profile is a hypothetical representation of the ideal customer, including demographics, preferences, behaviors, and needs.

Overall, the system ensures user anonymity while enabling targeted marketing based on comprehensive user profiles represented by multidimensional vectors.

### System Components:

The invention encompasses at least three main components: the portable terminal devices (one or more for each user), the management server, and the service provider device. This system is designed to function together seamlessly, with the portable terminal device being the user-owned and utilized device, typically a smartphone but not restricted to it. The service provider device, managed by a person or company offering services to the user, engages in profile marketing and delivers advertisements. The management server acts as the intermediary, connecting the service provider and the user while ensuring the user's personal information remains undisclosed.

### Behavioral Data and Multidimensional Vectors:

When users interact with their mobile terminal devices, data reflecting their behavior (referred to as “behavioral data”) are generated. These data form the basis for calculating the multidimensional vectors of the user profile. Unlike traditional methods relying solely on income and expenditure information, this system incorporates additional data sources such as exercise records, healthcare information, and social networking service (SNS) data to generate the multidimensional vectors. These multidimensional vectors describe various attributes of the user, including demographics and interests.

### Generation of Multidimensional Vectors:

Multidimensional vectors representing user attributes, such as web browsing history and buying behavior, can be generated using features like screen-capture and image recognition functions on smartphones. Health and exercise condition vectors, on the other hand, can be derived from sensor data collected by portable terminal devices. The user's web browsing history plays a crucial role in shaping the multidimensional vectors, which evolve over time based on the user's daily activities. Changes to the multidimensional vectors may occur as needed, at predetermined intervals, or regularly.

### Profile Marketing for Potential Customer Research:

An example will now be described in which the use of an intermediate server (management server) ensures user anonymity while providing a detailed profile for targeted marketing and service customization in a system comprising users equipped with portable terminal devices, service providers and an intermediate server.

The intermediate management server need not be configured as a single server device, it may be configured as multiple server devices and the servers may be implemented in the cloud such as AWS, for example. Thus, the “USERID” database and “USER CONTACT INFO” may be stored on different physical devices.

The system supports two processes: “Profile Marketing for Potential Customer Research” and the “Offer of Advertisements to Anonymous User.” The management server, responsible for executing both processes, stores user IDs and multidimensional vectors in correlation. Specifically, when executing the offer of advertisements to anonymous users, the management server stores user IDs, multidimensional vectors, and the users' contact information together.

a. Profile Marketing for Potential Customer Research:

The service provider sends text via the internet to the management server, describing attributes of goods or services or target users for profile marketing purposes, along with data requests for such marketing. This text is typically human-readable, such as “yellow, classy, and simple cashmere knitwear for women” or “black convertible electric vehicle with a 100 km longest range for the middle-class market”.

Upon receiving the text and data, the management server generates a goods/service profile vector or target user persona vector in the form of multidimensional vector. This multidimensional vector consists of multiple vectors, each assigned a tag corresponding to attributes like color, income, material preference, age, and gender. For instance, if the text includes “yellow, classy, and simple $500 cashmere knitwear for women,” the management server links vectors like “yellow” to “favorite color,” “$500 knitwear” to “annual income,” “cashmere” to “favorite material,” “30 or over” to “age,” and “female” to “gender.” The resulting multidimensional vector represents the goods/service profile or target user persona.

Next, the management server compares this goods/service profile vector or target user persona vector with each user's multidimensional user profile vector, identifying similarities in tagged vectors. If a user's multidimensional user profile vector matches the goods/service profile vector or target user persona vector above a certain threshold, they are considered a match. The management server then retrieves the corresponding user IDs and counts the number of matches, providing this information to the service provider for targeted marketing.

Specifically, embodiments may provide various levels of detail to the service provider regarding matches. The management server may notify the service provider of the number of users who matched. Alternatively, the management server may send the following to the service provider the number of users that matched AND the user ID of the matches or the number of users that matched AND the user ID of the matches AND the degree of matching. The service provider can use this information to understand potential customer demographics and tailor marketing strategies accordingly, ensuring user anonymity is maintained, especially as user IDs are periodically changed.

b. Offer of Advertisements to Anonymous Users:

Similar to profile marketing, the service provider sends text describing attributes of goods or services or target users for targeted advertising to the management server, along with relevant data.

Upon receiving this data, the management server generates a goods/service profile vector or target user persona vector in the form of multidimensional vector and compares it with each user's multidimensional user profile vector, identifying matches as before.

Advertisement data specified by the service provider are then transmitted to the contact information associated with matching user IDs, delivering targeted advertisements accordingly. Alternatively, if the number of matched users exceeds a predetermined threshold, the service provider can instruct the management server to deliver targeted advertisements to all matched users.

The service provider may receive information specifying the matched user IDs and associated multidimensional vectors from the management server, enabling further refinement of the target audience. They can then instruct the management server to deliver targeted advertisements to these refined user IDs. Again, embodiments may provide various levels of detail to the service provider regarding matches. The management server may notify the service provider of the number of users who matched and, if desired, the user ID of the matches or the number of users that matched and even the degree of matching data.

Hereinafter, embodiments and examples of the present disclosure will be described with reference to the accompanying drawings. In the drawings, elements with the same functions may be denoted by the same reference numerals. Although the accompanying drawings illustrate specific embodiments and implementations in accordance with the principle of the present disclosure, they are for understanding of the present disclosure. They should never be used to limit the claims.

In embodiments described herein, a portable terminal unit is equipped to generate multidimensional vectors based on data received from various sources, including a sensor array and behavioral data, entirely within a portable terminal unit. To enable this functionality, several hardware requirements must be considered. These requirements encompass both the sensing and processing components, aiming to efficiently capture and analyze the diverse inputs to produce meaningful multidimensional representations.

### Portable Terminal Units

The portable terminal units include a sensor array comprising various sensors capable of capturing relevant data inputs. The sensor array may include, but are not limited to, gyroscopes and accelerometers for motion detection and orientation tracking; biometric sensors for measuring physiological parameters such as heart rate, skin conductance, or temperature; environmental sensors for detecting ambient conditions like temperature, humidity, and light levels; location sensors such as GPS or inertial measurement units (IMUs) for spatial tracking. A robust processing unit is required to handle the aggregation and analysis of data from the sensor array and behavioral inputs. This processing unit may include a Central Processing Unit (CPU) for executing instructions and managing overall system operations; a Graphics Processing Unit (GPU) utilized for parallel processing tasks, such as data-intensive computations and visualization; a dedicated neural processing unit (NPU) for refinement of multidimensional vector generation; and a Digital Signal Processor (DSP) optimized for processing real-time sensor data and implementing signal processing algorithms. The processing unit should possess sufficient computational power and memory capacity to handle the complexity of multidimensional vector generation.

An embodiment includes a dedicated Vector Generation Integrated Circuit (IC) to optimize performance and energy efficiency. This specialized hardware accelerator is designed to execute vector-related operations efficiently, offloading processing tasks from the CPU, GPU or NPU. The vector generation IC should support parallel processing capabilities and be programmable to accommodate various algorithms and data formats. Integration of a dedicated IC can enhance the overall speed and efficiency of multidimensional vector generation while minimizing power consumption, making it well-suited for resource-constrained environments such as mobile devices. In addition to or as an alternative to the dedicated vector generation circuit, a software engine capable of operating on the hardware of a device such as a smartphone may be used for data collection, processing, and vector generation tasks. This software engine may include: sensor fusion algorithms: to integrate data from multiple sensors (including screen capturing) and derive meaningful insights; machine learning models: for pattern recognition and predictive analysis based on behavioral or image data; vectorization algorithms: for transforming raw data inputs into multidimensional vector representations. The software engine should be optimized for mobile platforms, leveraging hardware acceleration capabilities and minimizing resource utilization to ensure efficient operation on smartphones and wearable devices.

By incorporating these hardware components, including a sensor array, processing unit, dedicated vector generation IC, and software engine, it is possible to create a comprehensive system capable of generating multidimensional vectors based on diverse data inputs. This integrated approach enables the extraction of rich insights into user behavior and environmental context, facilitating personalized experiences and enhancing the functionality of smart devices.

In addition, the portable terminal unit hardware includes memory, a display, an input-output interface, a power supply, communication components, software, and bus interface components to facilitate communication and data exchange between the processor, memory, peripherals, and other integrated circuits.

Memory components, including RAM (Random Access Memory) and ROM (Read-Only Memory), store data and instructions necessary for the operation of the portable terminal unit. RAM provides volatile memory for temporary data storage, facilitating quick access by the CPU, while ROM stores essential system software and firmware.

The display component presents visual information to the user, such as graphical user interfaces, images, videos, and text. It interacts with the CPU and memory to render visual content based on user input and application requirements.

The input/output (I/O) interface encompasses various mechanisms for user interaction and data exchange. This includes touchscreens, physical buttons, audio input/output interfaces, visual input/output interfaces, and connectivity ports (e.g., USB, headphone jack). User inputs via these interfaces trigger actions within the portable terminal unit's software, while outputs provide feedback to the user.

Power supply components, such as batteries and charging circuits, ensure continuous operation of the portable terminal unit. The battery stores electrical energy, which powers the device's components, while the charging circuit manages the recharging process.

Communication modules enable the portable terminal unit to connect to external networks and devices. This includes cellular, Wi-Fi, Bluetooth, and NFC (Near Field Communication) modules. These modules facilitate data exchange, internet connectivity, and communication with other portable terminal units or peripherals.

The interaction of these components is orchestrated by the operating system and software applications running on the portable terminal unit. User interactions trigger events processed by the CPU, which in turn coordinates the activation of appropriate components to fulfill user requests. For example, when a user launches a messaging application, the CPU initiates processes to display the application interface on the screen, manage user input via the touchscreen or physical buttons, access data from memory, and utilize communication modules to send or receive messages over a network.

Utilizing a multidimensional vector to encapsulate stored behavioral, biometric, and sensor data collected from a portable terminal offers a robust framework for identification verification while upholding user privacy. Here's how it can be implemented:

Data Fusion: The portable terminal continuously aggregates diverse data from integrated sensors, capturing information about the user's activities, surroundings, and physiological state. This encompasses not only traditional biometric data but also data from gyroscopes, accelerometers, ambient light sensors, heart rate monitors, and more.

Vector Representation: All collected data is transformed into a multidimensional vector format. Each type of data, whether it's keystroke dynamics, facial features, ambient light levels, heart rate variability, or movement patterns, contributes to each vector in the different dimensions of the multidimensional vector.

Dimensionality Reduction: Techniques like PCA or autoencoders may be employed to reduce the dimensionality of the vector while retaining its discriminative power. This aids in managing the complexity of the data while preserving its informative content.

Privacy-Preserving Practices: Raw sensor data are never transmitted; only the vectorized representation is transmitted. This safeguards sensitive personal information, as even if the vector data were intercepted, reconstructing the original data would be exceedingly difficult.

Although the present embodiment contains fully detailed descriptions for those skilled in the art to implement the present disclosure, it should be understood that other implementations and embodiments are also possible, and changes to the configuration or structure as well as replacement of various elements, is possible without departing from the spirit or scope of the technical idea of the present disclosure. Therefore, the present disclosure should not be construed by being limited to the following descriptions.

The processes described herein are implemented using computer hardware and non-transitory computer-readable media including program instructions executable on a digital processor that include code sections of implementing the steps described.

Processing within a Smartphone:

The processing described below is executed using computer hardware including non-transitory computer readable media that includes program instructions on a digital processor for executing program instructions.

Example of Processing within a Smartphone:

The Core Application Processing Unit 1011 generates a multidimensional vector based on information obtained from various application processing units 1012 to 1019. This information is then stored in the core account set in the storage device 103. The Core Application Processing Unit 1011 employs predetermined or known mathematical calculation methods and IT technologies for this task.

With code segments read from specific software installed or embedded in the firmware of the application processing unit 1012, there exists an “online shopping and browsing” behavior capture unit. This unit operates as a Multi-modal Large Language Model (MLLM) in conjunction with screen and video capture functionalities. As a result, the application processing unit 1012 can automatically and dynamically recognize or identify the content the user is viewing, as well as assess the level of engagement (both in terms of duration and frequency) with said content while browsing the internet on the screen of the portable terminal.

The recognized information (referred to as ‘Recognized Item’) is sent to and stored in the core account set in the storage device 103.

The Core Application Processing Unit 1011 retrieves the Recognized Item information from the core account and analyzes it into attributes. These attributes are then allocated into equivalent dimensions—that is tantamount to forming the multidimensional space encapsulating the Recognized Item as a whole. The unit then sets a coordinate, namely a vector, of each of the attributes in each of the equivalent dimensions thus forming a multidimensional vector space encapsulating the Recognized Item.

The Core Application Processing Unit 1011, at the same time as its processing the attributes and generating vectors assigns a different tag to each of the dimensions, the tag specifying the specific dimension, and creates a set of those tags. Each dimension is assigned a different tag to specify its specific attribute.

The Core Application Processing Unit 1011 generates a multidimensional vector as a tensor product in the multidimensional vector space with separately tagged dimensions. This information (multidimensional vector as well as the set of the vectors in the dimensions thus separately tagged) is stored in the storage device 103.

The tensor product is calculated using mathematical formulations such as determinant or product formula, utilizing tensor product operators and basis vectors stored in the storage device 103.

In a similar manner, data from other processing units undergo similar processing to generate multidimensional vectors. As noted, in addition to data from apps used by the user, the other processing units may include, but are not limited to, gyroscopes and accelerometers for motion detection and orientation tracking; biometric sensors for measuring physiological parameters such as heart rate, skin conductance, or temperature; environmental sensors for detecting ambient conditions like temperature, humidity, and light levels; location sensors such as GPS or inertial measurement units (IMUs) for spatial tracking.

To enhance efficiency, each vector in the multidimensional vector space may be treated as an individual data point, with these data points then organized into a tensor structure. This tensor is defined by its shape, which indicates the number of data points along each dimension and the dimensions required to represent each vector.

For instance, suppose we have a dataset where each data point is depicted by a 3-dimensional vector, and there are a total of 100 such data points. In this scenario, we could represent them as a tensor with a shape of (100, 3). Here, the tensor would consist of 100 rows (each representing a data point) and 3 columns (each corresponding to a dimension of the vectors).

The Core Application Processing Unit 1011 sends the multidimensional vector information, along with the set of separately tagged dimensions-dimension tags, representing the Recognized Item, to the management server via a communication network. A unique USERID is associated with each portable terminal device. The portable terminal device transmits the USERID in connection with the multidimensional vector and dimension tags. Because data within the multidimensional vector is subject to change, the multidimensional vector is periodically (daily, for example) updated and an updated multidimensional vector and dimension tags are transmitted to the management server. The frequency at which updated multidimensional user profile vectors (together with USERID and dimension tags) are sent from the portable terminals can be at certain intervals (every 12 hours, every day, etc.), or whenever a change occurs in the multidimensional vector, or when a change in the multidimensional vector is greater than a specified threshold. Frequent updating is especially useful in the context data relating to web browsing as it may reflect on new and active interest in a product or service that is of interest to advertisers and service providers.

Example of Processing within the Management Server:

USER DATA (comprising the multidimensional vector, dimension tags and USERID) is stored in the management server database. Specifically, the management server dynamically stores, in device 203, a series of multidimensional vector information and sets of vectors in separately tagged dimensions received from the portal device via a communication network.

The service provider accesses the management server and inputs a set of attributes of the item they wish to advertise, market, or research, expressed in natural language.

The processing unit 201 in the management server, equipped with an LLM (large language modeling) function, analyzes the set of attributes to generate a corresponding multidimensional target profile vectors. The corresponding multidimensional target vector or set of vectors in the multidimensional vector space are matched with the multidimensional USER DATA vector information and set of vectors in separately tagged dimensions received from the portal device to some extent, the processing unit 201 compares the multidimensional vectors to calculate the extent of their similarity.

More specifically, the service provider connects to the management server through the communication network from their server, they utilize an input/output (I/O) device to submit a set of attributes describing the item they wish to advertise, market, or research, expressing these attributes in natural language.

Upon receiving this information, the processing unit 201 within the management server, equipped with either pre-installed or post-installed Large Language Modeling (LLM) functionality, analyzes it. It determines the multidimensional vector and the corresponding set of vectors in the multidimensional vector space based on the attributes provided by the service provider. Using the LLM function, it interprets the meaning of the dimensions' tags and attributes, seeking to find the set of vectors stored in device 203 that most closely matches the attributes of the item.

Once a degree of matching is established between the set of vectors in the tagged dimensions and the item's attributes, the processing unit 201 compares the multidimensional USER DATA vector in the tagged dimensions (i.e., the multidimensional vector space) with the multidimensional vector derived from the item's attributes (i.e., another multidimensional vector space). It calculates the extent of their similarity and stores this information in device 203

Subsequently, the service provider retrieves this information from device 203. Through the management server, which is connected to their server, they proceed to deploy advertisements, marketing strategies, or conduct research targeting users who possess both the matched multidimensional vector and the matched set of item attributes.

The service provider utilizes the information from the management server to deploy advertisements, marketing, or research targeted at users with matched multidimensional vectors and attribute sets.

To perform these functions, the management server includes computer hardware as described herein to provide a non-transitory computer readable media including program instructions executable on a digital processor for use in a system equipped to communicate with a plurality of user portable terminals each associated with a unique USERID and configured to collect user data; and configured to communicate with a plurality of service providers seeking to communicate with users having select attributes, the program instructions comprising (by way of example) code sections obtaining user data from said portable terminals; code sections that preprocess, cleanse, and normalize said user data and store the same as preprocessed user data; code sections generating multidimensional vectors representing user profiles based on said preprocessed user data; code sections storing the multidimensional vectors in association with the USERID; code sections obtaining requests from said service providers, comprising human-readable text describing attributes of targets for content; code sections that preprocess, cleanse, and normalize said the human-readable text and store the same as preprocessed text; code sections that generate multidimensional vectors representing target profiles based on said preprocessed text; code sections that compare multidimensional vectors associated with target profiles to multidimensional vectors associated with user profiles to identify similarities and patterns and identify matched users; and code sections that facilitate the delivery of content to matched users based on said comparisons, without disclosing user identities or content providers.

### Profile Marketing for Potential Customer Research:

The management server, responsible for executing both processes, stores user IDs and multidimensional vectors in correlation. Specifically, when executing the offer of advertisements to anonymous users, the management server stores user IDs and multidimensional vectors together.

### Profile Marketing for Potential Customer Research:

The service provider sends text via the internet to the management server, describing attributes of goods or services or target users for profile marketing purposes, along with data requests for such marketing. This text is typically human-readable, such as “yellow, classy, and simple cashmere knitwear for women” or “black convertible electric vehicle with a 100 km longest range for the middle-class market.”

Upon receiving the text and data, the management server generates a goods/service profile vector or target user persona vector in the form of multidimensional vector. This multidimensional vector consists of multiple vectors, each assigned a tag corresponding to attributes like color, income, material preference, age, and gender. For instance, if the text includes “yellow, classy, and simple $500 cashmere knitwear for women,” the management server links vectors like “yellow” to “favorite color,” “$500 knitwear” to “annual income,” “cashmere” to “favorite material,” “30 or over” to “age,” and “female” to “gender.” The resulting multidimensional vector represents the goods/service profile or target user persona.

Next, the management server compares this goods/service profile vector or target user persona vector with each user's multidimensional user profile vector, identifying similarities in tagged vectors. If a user's multidimensional user profile vector matches the goods/service profile vector or target user persona vector above a certain threshold, they are considered a match. The management server then retrieves the corresponding user IDs and counts the number of matches, providing this information to the service provider for targeted marketing. Embodiments may provide various levels of detail to the service provider regarding matches. The management server may notify the service provider of the number of users who matched. Alternatively, the management server may send the following: to the service provider the number of users that matched AND the user ID of the matches or the number of users that matched AND the user ID of the matches AND the degree of matching data.

The service provider can use this information to understand potential customer demographics and tailor marketing strategies accordingly, ensuring user anonymity is maintained, especially as user IDs are periodically changed.

b. Offer of Advertisements to Anonymous Users:

Similar to profile marketing, the service provider sends text describing attributes of goods or services or target users for targeted advertising to the management server, along with relevant data.

Upon receiving this data, the management server generates a goods/service profile vector or target user persona vector in the form of multidimensional vector, and compares it with each user's multidimensional user profile vector, identifying matches as before.

Advertisement data specified by the service provider is then transmitted to the contact information associated with matching user IDs, delivering targeted advertisements accordingly. Alternatively, if the number of matched users exceeds a predetermined threshold, the service provider can instruct the management server to deliver targeted advertisements to all matched users.

The service provider may receive information specifying the matched user IDs and associated multidimensional vectors from the management server, enabling further refinement of the target audience. They can then instruct the management server to deliver targeted advertisements to these refined user IDs.

In summary, both profile marketing and targeted advertising processes ensure user anonymity while allowing for effective marketing strategies based on user attributes.

In an embodiment, the service provider sends to the intermediate management server Market Persona information-which could be in the form of natural language Market Persona information or in the form of a multidimensional Market Persona vector with appropriate dimension tags and provider ID. In this context Market Persona means a comprehensive description that can include either or both the product/service profile and the detailed profile of the target customer. A Product/Service Profile includes details about the product or service, including its features, benefits, and unique selling points. A Customer Profile is a hypothetical representation of the ideal customer, including demographics, preferences, behaviors, and needs.

### Exemplary Overall Configuration of System

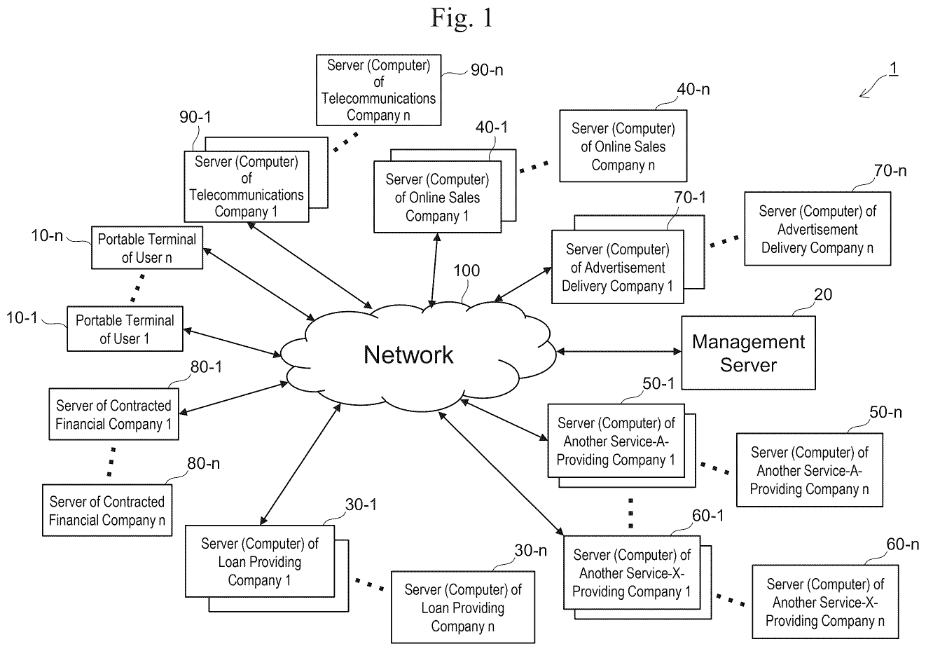

FIG. 1 illustrates an exemplary overall configuration of a system for the secure generation and processing of multidimensional vectors in support of anonymized user profiling and content delivery. The service-providing system 1 uses the portable terminal units to manage various services and provides the various services to users according to the present embodiment. The system broadly includes a plurality of distributed portable terminals 10, an intermediate management server 20 for anonymized user profiling and content delivery and merchants, service providers and advertisers who seek to use the system to transact with targeted users (those with portable terminals). Code segments loaded onto and stored on the portable terminals 10 used portable terminal resources to generate and transmit multidimensional vectors, dimensional tags and a unique USERID to the intermediate management server 20. As noted, frequency at which updated multidimensional user profile vectors (together with USERID and dimension tags) are sent from the portable terminals can be at certain intervals (every 12 hours, every day, etc.), or whenever a change occurs in the multidimensional vector, or when a change in the multidimensional vector is greater than a specified threshold. The intermediate management server 20 communicates with the portable terminals and various service providers and merchants 30, 40, 50, 60 over the Network 100.

As noted, the intermediate management server need not be configured as a single server device, it may be configured as multiple server devices and the servers may be implemented in the cloud such as AWS, for example. Thus, the “USERID” database and “USER CONTACT INFO” may be stored on different physical devices.

The code segments stored in the portable terminals perform manifold functions or any other similar mathematical expressions such as “functions in multidimensional spaces”; hereinafter, the same) directly on portable terminal devices.

The service-providing system shown in FIG. 1 includes portable terminals (which may also be fixed-line terminals) 10_1 to 10_n, each of which is held or owned by a user and which accesses a network when operated by the user. A unique USERID is associated with each terminal. An intermediate management server 20 (which may be implemented on multiple physical or virtual servers) manages information or data (which includes multidimensional vectors representing user profiles described below, “multidimensional user profile vectors”) sent from the portable terminals 10_1 to 10_n of the users 1 to n. The intermediate management server 20 also manages information or data sent from servers of various companies, and manages services provided by the various companies; servers 30_1 to 30_n of financial service or fintech companies 1 to n, each of which determines credit conditions (which include information such as an loan amount and a repayment period) for the relevant user on the basis of the multidimensional user profile vector provided by the management server 20, and sends the credit/loan conditions to the management server 20; servers 40_1 to 40_n of online sales companies (merchants) 1 to n, each of which determines a group of goods/service matching the relevant user (with high possibility) on the basis of the multidimensional user profile vector provided by the management server 20, generates an offer for the user, and sends the offer to the management server 20; servers 50_1 to 50_n and 60_1 to 60_n of service providers of other services-A-to-X (e.g., complete medical checkup introducing services and human resource providing services)-providing companies 1 to n, each of which determines various services matching the relevant user (with high possibility) on the basis of the multidimensional user profile vector provided by the management server 20, generates an offer for the user, and sends the offer to the management server 20; servers 70_1 to 70_n of advertisement delivery companies 1 to n, each of which determines an advertisement matching the relevant user (with high possibility) on the basis of the multidimensional user profile vector provided by the management server 20 and sends information on the advertisement to the management server 20; servers 80_1 to 80_n of financial companies 1 to n, such as banks, that are contracted by the users 1 to n; and servers 90_1 to 90_n of telecommunications companies 1 to n, each of which is accessed by each service-providing company on the basis of information that identifies one of the portable terminals 10_1 to 10_n of the users provided by the management server 20 so that each service-providing company obtains from the server information on the debit account for payment of communication charges for the telecommunications company contracted by the user for the portable terminal. All of the aforementioned servers are connected to one another and may transfers data over a network 100. The servers may be cloud based or located on the premises of a service provider or merchant.

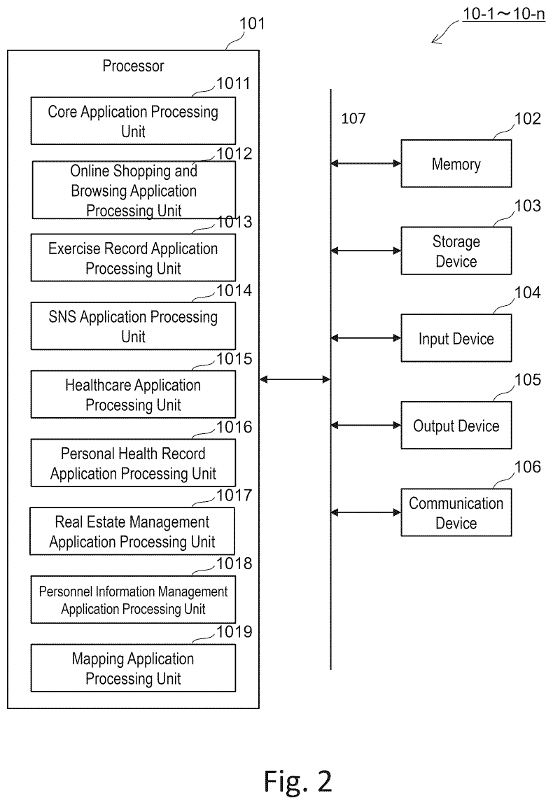

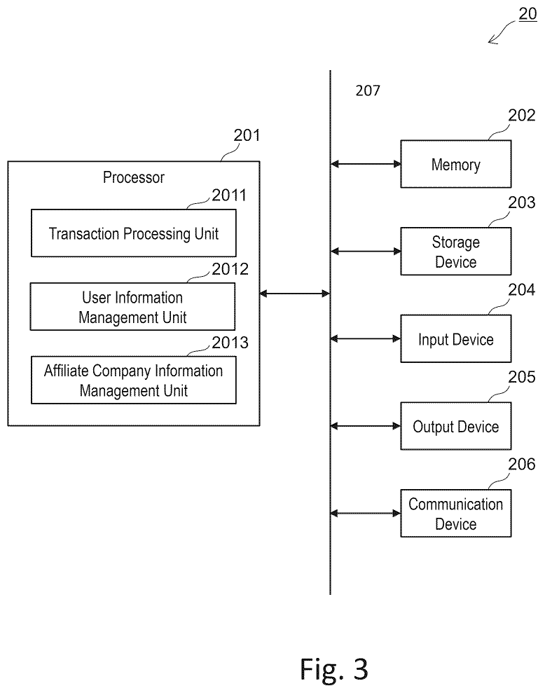

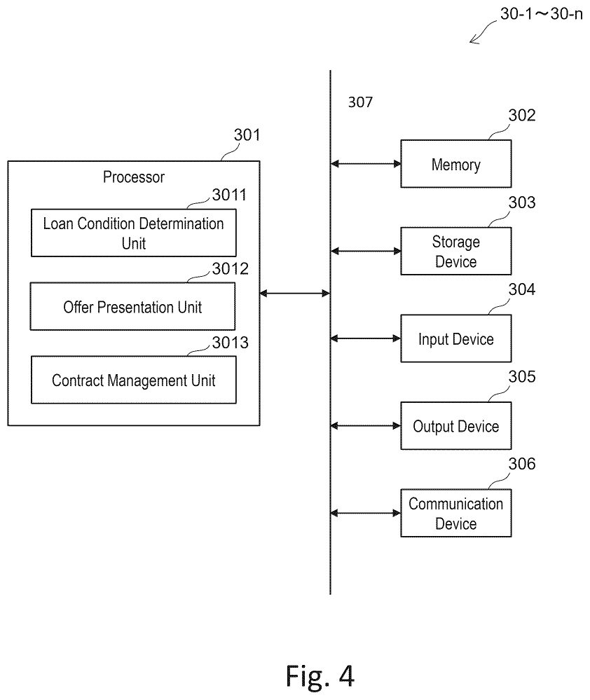

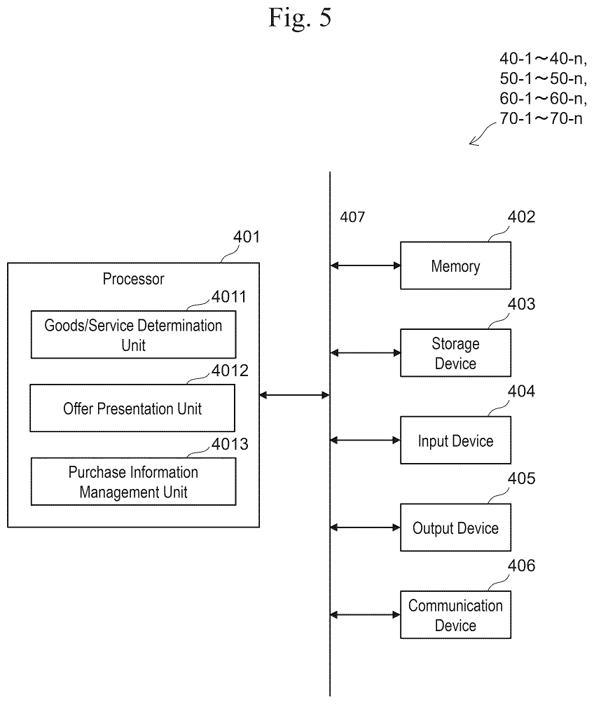

FIGS. 2 to 5 illustrate exemplary internal configurations of devices that form the service-providing system 1. FIG. 2 illustrates an exemplary internal configuration of each of the portable terminals 10_1 to 10_n of the users 1 to n. FIG. 3 illustrates an exemplary internal configuration of the management server 20. FIG. 4 illustrates an exemplary internal configuration of each of the servers 30_1 to 30_n of the financial service/financial service companies 1 to n. FIG. 5 illustrates the internal configuration of each of the servers 40_1 to 40n of the online sales companies 1 to n, and the n servers 50_1 to 50_n and 60_1 to 60_n of the other services-A-to-X-providing companies 1 to n. As illustrated in FIGS. 2 to 5, each device that forms the service-providing system includes computing hardware and code segments stored in memory. In each instance, the computer hardware includes a processor, memory, a storage device, an input device, an output device, and a communication device. In addition, code segments stored in the storage device are executable in the processor to provide the functions described herein.

### Portable Terminal

In addition to features described previously, the portable terminal units may execute various programs as described below. As illustrated in FIG. 2, each of the portable terminals 10_1 to 10_n includes a processor 101 that executes various programs (code segments) stored on the terminal; a memory 102 that stores various programs as code segments and various parameters; a storage device 103 that stores computation results and obtained information; an input device 104 including a keyboard, a touch panel, various buttons, a microphone, and the like (either one or more of which may be included in the input device); an output device 105 including a display device, a printer, a speaker, and the like (either one or more of which may be included in the output device); and a communication device 106 adapted to be connected to the network 100 to communicate with external devices. Though not illustrated, each of the portable terminals 10_1 to 10_n may also include a GPS function, an accelerometer, a vibration sensor, a pulse sensor, an orientation sensor, and a gyro sensor, for example. Such sensors operate in cooperation with an exercise record application processing unit 1013 or a mapping application processing unit described below. The portable terminals include code segments that allow capture of web browsing history and buying behavior,

The processor 101 reads various programs stored as code segments from the memory 102, expands the programs in a built-in processor memory and executes the programs as appropriate. FIG. 2 illustrates a state in which various programs are expanded in the built-in memory of the processor 101. The processor 101 executes a core application processing unit 1011, an online shopping and web browsing application processing unit 1012, an exercise record application processing unit 1013, an SNS application processing unit 1014, a healthcare application processing unit 1015, a personal health record application processing unit 1016 (a medicine notebook application processing unit), a real estate management application processing unit 1017, a personnel information management application processing unit 1018, and a mapping application processing unit 1019 as programs. They are just examples of applications in which demographic, economic, behavioral and health data are collected and reflect user attributes. The applications are implemented by code segments that are executable in the respective processor. The code segments may be retrieved from storage or retrieved from the network and stored in memory for access as needed by the respective processor.

The core application processing unit 1011 is an application program that has been either pre-installed as firmware in each of the portable terminals 10 1 to 10 by the terminal manufacturer, or downloaded to each of the portable terminals 10_1 to 10_n by the user from a site (i.e., website of a service) provided by the management server 20 or an application providing site of a third party, for example. The core application processing unit 1011 includes code segments that are executable in the processor to generate multidimensional vectors and tags as described herein based on data from the various processing units and sensors on the terminal, storing the same and transmitting the vectors, tags and USERID information to the management server. A USERID in associated with the a core account within the storage device 103 of each of the portable terminals 10_1 to 10_n, The terminals may also execute direct deposit or withdrawal of electronic money into/from the core account or execute electronic payment through the core account using the portable terminal and obtains its record, and also communicates with a financial company, such as a bank, with which the user has a contract (i.e., has an account) on an as-needed basis or periodically, as described below, so that the user obtains information on the history of transactions with the financial company (e.g., information on deposit and withdrawal of money (such as information on the amount of money, transfer destination, and date), information on debt, and information on the loan repayment status) or information on the usage history of a credit card, for example, and then stores the information into the storage device 103 in association with the core account. In addition, the core application processing unit 1011 may be configured to operate in cooperation with a server of a bank where the debit account for payment of fees (i.e., communication charges) for a portable phone or a fixed-line phone is provided, and obtain information on the balance of the account or the history of the telephone fees withdrawn from the account one by one. Further, the core application processing unit 1011 operates in cooperation with various application processing units described below, and stores information obtained by the various application processing units into the storage device 103 in association with the core account. Then, the core application processing unit 1011 generates data sets containing user data in the form of vectors, multidimensional vectors and tensors on the basis of the information stored in the storage device 103 in association with the core account.

The online shopping and web browsing application processing unit 1012 includes code segments executable of the processor so that the application is configured to operate in cooperation with the core application processing unit 1011 and an online-shopping-related application that has been loaded onto the portable terminal 10_k of the user (which means a portable terminal of the k-th user (where k=1 to n); hereinafter the same). When the user purchases some goods or services via the online-shopping-related application that has been loaded onto the portable terminal, information on the purchase is obtained, and the obtained purchase information is delivered to the core application processing unit 1011 on an as-needed basis or periodically. When the user browses websites via the web-browsing-related application that has been loaded onto the portable terminal, information on the web-browsing is obtained, and the obtained web-browsing information is delivered to the core application processing unit 1011 on an as-needed basis or periodically. Alternatively, the core application processing unit 1011 may be configured to periodically inquire of the online shopping and web browsing application processing unit 1012 to obtain the purchase and web-browsing information of the user.

The exercise record application processing unit 1013 is configured to operate in cooperation with the core application processing unit 1011 and obtains information on the exercise state of the user of the portable terminal 10_k on an as-needed basis and/or periodically, and then delivers the obtained information on the exercise state of the user to the core application processing unit 1011. For example, when the user performs an exercise, the portable terminal 10_k measures the duration of the exercise and the magnitude of a load (which is defined by the magnitude of a motion measured by each sensor, for example) using the aforementioned accelerometer, vibration sensor, and pulse sensor, for example. Then, the exercise record application processing unit 1013 automatically computes the amount of exercise of the user using information on the duration of exercise and the magnitude of the load measured by each sensor (for example, the amount of exercise can be computed through computation of the duration of the exercise and consumed calories), and delivers it to the core application processing unit 1011.

The SNS application processing unit 1014 is configured to operate in cooperation with the core application processing unit 1011 and an SNS (social networking service)-related application that has been loaded onto the portable terminal 10_k of the user, and obtains information on the friendship status of the user (i.e., owner) of the portable terminal 10_k in the SNS (e.g., information on the use frequency of the SNS, the number of friends, and communities to which the user belongs), and then delivers the obtained information on the friendship status to the core application processing unit 1011 on an as-needed basis or periodically.

The healthcare application processing unit 1015 is configured to operate in cooperation with the core application processing unit 1011 and a healthcare-related application that has been loaded onto the portable terminal 10_k of the user, and obtains information on the healthcare of the user (i.e., owner) of the portable terminal 10_k (e.g., the body weight of the user, the heart rate or pulses obtained by the aforementioned pulse sensor, and results of a medical checkup) from the healthcare-related application that has been loaded onto the portable terminal, and then delivers the obtained information on the healthcare to the core application processing unit 1011 on an as-needed basis or periodically. In addition, information on the body weight of the user and the results of the medical checkup are updated by periodically inquiring of the user from the healthcare application processing unit 1015, for example. Alternatively, the healthcare application processing unit 1015 may access an external healthcare information management server (not illustrated in FIG. 1) and obtain at least a part of information on the healthcare of the target user registered in the server.

The personal health record application processing unit 1016 is configured to operate in cooperation with the core application processing unit 1011 and a medication-related application that has been loaded onto the portable terminal 10_k of the user, and obtains information on the medication state of the user (i.e., owner) of the portable terminal 10_k (e.g., the types of drugs, the frequency of medication, and effectiveness of the drugs) via the medication-related application that has been loaded onto the portable terminal, and then delivers the obtained information on the medication state to the core application processing unit 1011 on an as-needed basis or periodically. The information on the medication state may also be obtained by accessing an external medication data management server (not illustrated in FIG. 1), for example. Alternatively, the user may, upon purchasing a drug in a pharmacy, register information on the purchased drug in the portable terminal 10_k via a medication-related application that has been loaded onto the portable terminal so that the personal health record application processing unit 1016 can read the information. Alternatively, when the user purchases a drug in some shop, the personal health record application processing unit 1016 may communicate with the online shopping and web browsing application processing unit 1012 and obtain information on the purchased drug for management purposes.

The real estate management application processing unit 1017 is configured to operate in cooperation with the core application processing unit 1011, and obtains information on a real estate owned by the user (i.e., owner) of the portable terminal 10_k (e.g., the type of the real estate, address, size, and the age of the real estate if it is a building), and then delivers the obtained information on the real estate to the core application processing unit 1011 on an as-needed basis or periodically. The information on the real estate owned by the user can be obtained by inquiring of the user from the real estate management application processing unit 1017, for example. Alternatively, the real estate management application processing unit 1016 may access an external real estate information management server (not illustrated in FIG. 1) to obtain information on a real estate of the target user registered in the server. Further, the user may be able to update his/her own real estate information by operating his/her portable terminal 10_k.

The personnel information management application processing unit 1018 is configured to operate in cooperation with the core application processing unit 1011, and obtains the personnel information of the user (i.e., owner) of the portable terminal 10_k (e.g., age, academic background, business career, annual income, and occupation), and then delivers the obtained personnel information to the core application processing unit 1011 on an as-needed basis or periodically. The personnel information of the user is obtained by inquiring of the user from the personnel information management application processing unit 1018 periodically (e.g., once a year), for example. Further, the user may be able to update his/her personnel information by operating his/her portable terminal 10_k.

The mapping application processing unit 1019 is configured to operate in cooperation with the GPS function and the core application processing unit 1011, and obtains travel information of the user (i.e., owner) of the portable terminal 10_k (e.g., travel date and time, travel route, place of stay, duration of stay, and duration of travel) by utilizing the GPS function, and then delivers the obtained travel information to the core application processing unit 1011 on an as-needed basis or periodically. In addition, the mapping application processing unit 1019 estimates the residential zone of the user (i.e., owner) on the basis of the travel information, and obtains information on the living area of the estimated residential zone, and then delivers the information to the core application processing unit 1011.

As described above, although each of the portable terminals 10_1 to 10_n includes various processing units 1011 to 1019, it need not include all of such processing units other than the core application processing unit 1011, and it may also include other processing units. For example, predetermined processing units (or predetermined application programs) may be installed on each of the portable terminals 10_1 to 10_n as appropriate and used. Then, information obtained by the newly installed application programs may be used to compute the multidimensional vector of the user profile. Thus, the component vectors of the multidimensional user profile vector reflect the profile information that is discernable from the particular terminal the user is using. If a particular terminal lacks the ability to monitor a health indicator, then the multidimensional user profile vectors generated by that terminal will not include such data. The content of a multidimensional user profile vector could vary significantly, but because there are tags associated with the vectors comprising a multidimensional user profile vector, the management server can access whatever data are provided.

### Management Server

The management server 20 is a server computer of an intermediary company that manages a service site for allowing transactions to be performed between each user and each affiliate company (a merchant, advertiser, service provider that seeks to target certain users for interaction).

In an embodiment, the management server 20 includes computing equipment for executing code segments that when executed generate multidimensional target profile vectors, based on the attributes of goods/service/target users input in natural language, and compare the multidimensional target profile vectors with the multidimensional user profile vectors to calculate the similarity as described below.

Though described as a single server, the intermediate management server 20 need not be configured as a single server device, it may be configured as multiple server devices and the servers may be implemented in the cloud such as AWS, for example. Thus, the “USERID” database and “USER CONTACT INFO” may be stored on different physical devices.

As illustrated in FIG. 3, the management server 20 includes a processor 201 that executes various installed programs (code segments); a memory 202 that stores various programs and various parameters; a storage device 203 that stores multidimension vectors received from terminals in association with tags and USERIDs and also stores results of computation and obtained information; an input device 204 including a keyboard, a touch panel, various buttons, a microphone, and the like (either one or more of which may be included in the input device); an output device 205 including a display device, a printer, a speaker, and the like (either one or more of which may be included in the output device); and a communication device 206 adapted to be connected to the network 100 to communicate with external devices, such as the portable terminals 10_1 to 10_n, the servers 30_1 to 30_n of the financial service companies 1 to n, the servers 40_1 to 40_n of the online sales companies 1 to n, the servers 50_1 to 50_n and 60_1 to 60_n of the services-A-to-X-providing companies 1 to n, and the servers 70_1 to 70_n of the advertisement delivery companies 1 to n.

The processor 201 reads various programs (code segments) from the memory 202, expands the programs in a built-in memory (not illustrated), and executes the programs as appropriate. FIG. 3 illustrates a state in which various programs are expanded in the built-in memory of the processor 201. The processor 201 executes a transaction processing unit 2011, a user information management unit 2012, and an affiliate company information management unit 2013 as programs.

The transaction processing unit 2011 coordinates the interaction between user information and affiliate companies by matching user profiles received from the portable terminal devices to target profiles generated based on queries from businesses (affiliate customers) by, for example, executing a process of presenting offers related to various goods and service transactions between the portable terminals 10_1 to 10_n and the servers 30_1 to 30_n of the financial service companies, the servers 40_1 to 40_n of the online sales companies, or the servers 50 to 50_n and 60_1 to 60_n of the services-A-to-X-providing companies, for example, and managing the transactions.

An embodiment of the intermediate management server 20 for anonymized user profiling and content delivery includes code segments executed in the transaction processing unite 2011 in connection with a system comprising the user terminals 10_1 to 10_n. In this embodiment, each user terminal is associated with a user and equipped with computing and communication equipment including a processor, memory, and code segments configured to: Collect user data such as browsing history, purchase history, demographic information, and interaction patterns; Generate multidimensional user profile vectors, where each vector includes dimensions tagged with attributes such as interests, behaviors, and preferences; Transmit the multidimensional user profile vectors and associated dimension tags, along with a unique USERID, to the intermediate management server.

A plurality of service providers (e.g., 30, 40, 50, 60, 70) seeking to provide content to target users with select attributes and configured to submit Market Persona requests comprising human-readable text describing a set of Market Persona attributes, which may include desired customer demographics, psychographics, behaviors, and specific interests.

As shown in FIG. 3, the intermediate management server 20 for anonymized user profiling and content delivery, comprising computing equipment including a processor 201, memory 202, storage device 203, input device 204, output device 205, communication device 206, and a data bus 207, and further comprising code segments executable in the processor (or multiple processors) to perform process steps of:
Receiving multidimensional user profile vectors and dimension tags from user terminals, each vector associated with a unique USERID, where the vectors include:
   Demographic data (e.g., age, gender, location).
   Psychographic data (e.g., lifestyle, values, interests).
   Behavioral data (e.g., browsing history, purchase history, interaction patterns).
Storing the multidimensional Market Persona vectors and user profile vectors in a database for efficient retrieval and processing.
Receiving Market Persona requests from service providers, wherein the Market Persona requests include detailed human-readable text descriptions of desired Market Persona attributes.
Converting the received Market Persona attributes into a multidimensional Market Persona vector, where each dimension is tagged with metadata corresponding to specific attributes such as age, gender, interests, purchasing behavior, and other relevant factors.
Matching the multidimensional Market Persona vector against the stored multidimensional user profile vectors using a vector matching algorithm to identify alignment between the Market Persona attributes and user profile attributes.
Calculating a matching degree for each user profile vector to determine the deviation in alignment with the Market Persona vector, where the matching degree indicates how closely a user's profile matches the desired attributes specified by the service provider.
Transmitting data to the service provider, including:
The total number of users matching the Market Persona attributes.
The USERIDs of the matching users.
The matching degree for each user, indicating the deviation in alignment with the Market Persona attributes.

The intermediate management server 20 may further utilize natural language processing (NLP) algorithms to convert human-readable Market Persona attributes into structured multidimensional vectors. The intermediate management server of this embodiment may store user profile vectors and Market Persona vectors in a distributed database system to facilitate efficient access and processing. In practice the intermediate management server of this embodiment may be implemented using multiple server devices and can be hosted on cloud platforms such as AWS. A non-transitory computer-readable medium storing instructions that, when executed by a processor, cause the intermediate management server to perform the method described above.

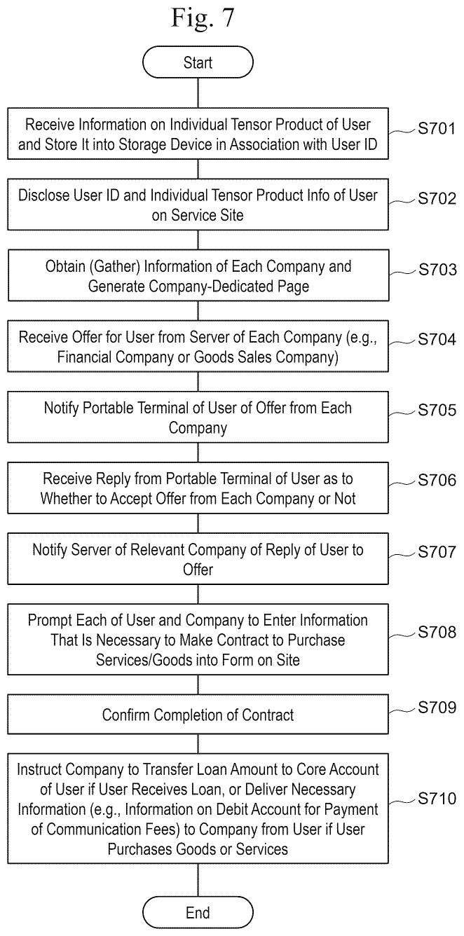

Another exemplary operation of the transaction processing unit 2011 will be described in detail later (see FIG. 7).

The user information management unit 2012 receives from each of the portable terminals 10_1 to 10_n of the users information that links the USERID to the multidimensional vector of the user profile generated in the portable terminals 10_1 to 10_n, and stores the information that links the USERID to the multidimensional vector of the user profile into the storage device 203 in association with the USERID assigned to each user. In addition, the User Information Management Unit 2012 may generate a dedicated website (i.e., personal page) that can be viewed only by each user on the management server 20 and posts information on offers from various service-providing companies on the page. The operation of the User Information Management Unit 2012 will also be described in detail later (FIG. 7).

The affiliate company information management unit 2013 obtains information from each of the merchants, advertisers and service companies interacting with the system. Examples include the financial service companies 1 to n, the online sales companies 1 to n, the advertisement delivery companies 1 to n, and the services-A-to-X-providing companies 1 ton (e.g., the address, telephone number, representative, the type of business, such as services or goods handled, and the form of business of the company) as well as information on an offer from each company for each user, and stores the information into the storage device 203 together with the identification ID of each company. In addition, the affiliate company information management unit 2013 generates a dedicated page (i.e., company's dedicated page (a page dedicated to a company)) that can be operated and viewed only by each company described above on the management server 20, and posts, on the page, the degree of the similarity calculated with the multidimensional vector of each user profile and the same of the goods or service profile generated by the processor 201 based on the information of the goods or service provided by the company. In addition, the affiliate company information management unit 2013 reads information on a desired company from the storage device 203 as needed and sends the information to the transaction processing unit 2011.

### Servers of Financial Service Companies

Each of the servers 30_1 to 30_n of the financial service companies 1 to n is a server of a company that provides loan services to each user whose individual credit rating is disclosed on the company's dedicated page of the service site. Each of the servers 30_1 to 30_n includes a processor 301 that executes various installed programs; a memory 302 that stores various programs and various parameters; a storage device 303 that stores results of computation and obtained information; an input device 304 including a keyboard, a touch panel, various buttons, a microphone, and the like (either one or more of which may be included in the input device); an output device 305 including a display device, a printer, a speaker, and the like (either one or more of which may be included in the output device); and a communication device 306 adapted to be connected to the network 100 to communicate with external devices, such as the portable terminals 10_1 to 10_n and the management server 20.

The processor 301 reads various programs from the memory 302, expands the programs in a built-in memory (not illustrated), and executes the programs as appropriate. FIG. 4 illustrates a state in which various programs are expanded in the built-in memory of the processor 301. The processor 301 executes a loan condition determination unit 3011, an offer presentation unit 3012, and a contract management unit 3013 as programs.

The loan condition determination unit 3011 obtains information on the individual credit rating of each user provided by the management server 20, and determines loan conditions for the target user. For example, information (i.e., parameters) on loan conditions corresponding to each individual credit rating is stored in the memory 302 or the storage device 303 in advance, and the loan condition determination unit 3011 reads information on the loan conditions corresponding to the individual credit rating of the target user obtained from the management server 20. Then, for example, a person in charge of the financial service company finally checks the loan conditions read, and if there is no problem, he/she enters a final determination instruction into the loan condition determination unit 3011 so that the loan condition determination unit 3011 delivers information on the loan conditions to the offer presentation unit 3012.

The offer presentation unit 3012 gathers the information on the loan conditions obtained from the loan condition determination unit 3011 and the target user ID, and sends to the management server 20 the user ID and the information on the loan conditions to be offered to the user using the communication device 306.

The contract management unit 3013, after checking that the user has concluded a contract with the financial service company, transfers the contracted loan amount to the core account in the portable terminal 10_k of the user. The contract management unit 3013 obtains from the management server 20 information that identifies a portable terminal associated with an ID of the contracted (i.e., loaned) user, that is, the portable terminal 10_k of the user, and accesses the server 90_k of the telecommunications company k contracted by the user of the portable terminal 10_k so as to obtain information on the debit account for payment of communication charges of the user, and then stores the obtained information into the storage device 303 in association with the user ID. If the user who had been offered the loan conditions does not conclude a contract even when he/she is quite close to the deadline or the deadline is over (if the user does not indicate his/her intention to receive the loan or not on the service site provided by the management server 20), the contract management unit 3013 requests the management server 20 to remind the user to indicate his/her intention.

Although the loan conditions are automatically determined using parameters and the like herein, a person in charge of the financial service company may send loan conditions, which have been determined by a (the) person on the basis of the individual credit rating, to the management server 20 via a server of the financial company.

### Servers of Online Sales Company, Service-Providing Company and Advertisement Delivery Company

Each of the servers 40_1 to 40_n of the online sales companies 1 to n determines a group of goods/service to be offered to each user on the basis of the similarity of the multidimensional vector of the goods/service profile to the same of each user profile (i.e., a group of goods/service that appears to be best for the target user in terms of matching the related multidimensional vectors), and posts the offer on the personal page of the service site, thus promoting the user to purchase the goods/service. In addition, each of the servers 50_1 to 50_n and 60_1 to 60_n of the other services-A-to-X-providing companies 1 to n determines a service to be offered to each user on the basis of the similarity of the multidimensional vector of the goods/service profile to the same of each user profile (i.e., a goods/service that appears to be best for the target user in terms of matching the related multidimensional vectors), and posts the offer on the personal page of the service site, thus promoting the user to conclude a contract. Each of the servers 70_1 to 70_n of the advertisement delivery companies 1 to n requests the management server 20 to post an advertisement that appears to be best on the personal page of the service site on the basis of the similarity of the multidimensional vector of the goods/service profile to the same of each user profile that has been uploaded to the company's dedicated page of the service site provided by the management server 20. Although the personal information of the relevant user is not posted on the company's dedicated page of the service site, the page has posted the similarity degree of the multidimensional vector of the good/service profile to the same of each user profile reflecting his/her living area information, health information, economic credit information, personnel information, and the like of the user. Therefore, such similarity is considered to have a considerable advertisement value for the advertisement delivery companies 1 to n.

Each of the servers 40_1 to 40_n, 50_1 to 50_n, 60_1 to 60_n, and 70_1 to 70_n of the online sales companies, other various service-providing companies, and the advertisement delivery companies includes a processor 401 that executes various installed programs; a memory 402 that stores various programs and various parameters; a storage device 403 that stores results of computation and obtained information; an input device 404 including a keyboard, a touch panel, various buttons, a microphone, and the like (either one or more of which may be included in the input device); an output device 405 including a display device, a printer, a speaker, and the like (either one or more of which may be included in the output device); and a communication device 406 adapted to be connected to the network 100 to communicate with external devices, such as the portable terminals 10_1 to 10_n and the management server 20.

In an embodiment, the series of the processes related to the management server and the company server processing include, in the management server 20, i) generation of the multidimensional vector of the good/service profile in the separately tagged dimensions corresponding to separate attributes of the good/service based on the information of the good/service profile input by the company in the form of texts (natural language); ii) comparison between the multidimensional vector of the user profile in the corresponding tagged dimensions and the multidimensional vector of the good/service profile above, and iii) calculation of the similarity degree of those two multidimensional vectors,

The processor 401 reads various programs (code segments) from the memory 402, expands the programs in a built-in memory (not illustrated), and executes the programs as appropriate. FIG. 5 illustrates a state in which various programs are expanded in the built-in memory of the processor 401. The processor 401 executes a goods/service determination unit 4011, an offer presentation unit 4012, and a purchase/contract information management unit 4013 as programs.

The goods/service determination unit 4011 obtains information on the multidimensional vector of each user profile provided by the management server 20, and determines goods (i.e., a group of goods) or a service (i.e., a group of services) for the target user. The goods/service determination unit 4011 reads information on the group of goods or the group of services corresponding to the multidimensional vector of the target user obtained from the management server 20. In an embodiment, the series of the processes related with the management server and the company server again included, in the management server 20: i) generation of the multidimensional vector of the good/service profile in the separately tagged dimensions corresponding to separate attributes of the good/service based on the information of the good/service profile input by the company in the form of texts (natural language); ii) comparison between the multidimensional vector of the user profile in the corresponding tagged dimensions and the multidimensional vector of the good/service profile above; and iii) calculation of the similarity degree of those two multidimensional vectors. Based on this analysis, the best match or matches (if any) are determined and

Furthermore, if necessary, a person in charge of the online sales company or the service-providing company, for example, finally checks the read information on the group of goods or the group of services, and if there is no problem, he/she enters a final determination instruction into the goods/service determination unit 4011 so that the goods/service determination unit 4011 delivers information on the group of goods or the group of services to the offer presentation unit 4012.

The offer presentation unit 4012 gathers the information on the group of goods or the group of services to be offered to each user, which has been obtained from the goods/service determination unit 4011, and the target user ID, and sends to the management server 20 the user ID and the information on the group of goods or the group of services to be offered to the user using the communication device 406.

The purchase information management unit 4013, after checking that the user has concluded a contract with the company, obtains from the management server 20 information that identifies a portable terminal associated with the ID of the contracted user, that is, the portable terminal 10_k of the user. Then, the purchase information management unit 4013 accesses a server 80_k of a telecommunications company contracted by the user for the portable terminal so as to obtain information on the debit account for payment of the communication charges of the user, and then stores the information into the storage device 403 in association with the user ID. In addition, if the target user who had been offered the goods or services does not indicate his/her intention to purchase the goods or services even when he/she is quite close to the preset deadline (if the user does not indicate his/her intention to purchase the goods or services or not on the service site provided by the management server 20), the purchase information management unit 4013 requests the management server 20 to remind the user to indicate his/her intension.

### Process Performed on Portable Terminal of User

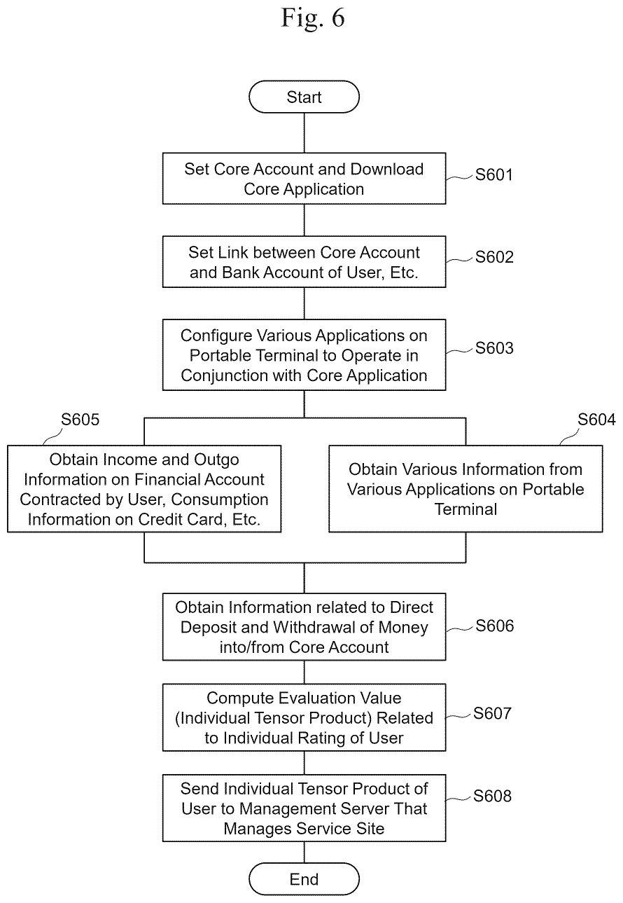

FIG. 6 is a flowchart for illustrating the operation of a core application executed on each of the portable terminals 10_1 to 10_n of the users. In this specification, the operation of the core application will be described on the assumption that the subject that performs each step (i.e., steps other than step 601) is the core application processing unit 1011. However, the subject may also be the processor 101 since the processor 101 executes the core application processing unit 1011.

### Step 601

The processor 101 accesses the management server 20 or an appropriate external server using the communication device 106 in response to an operation of the user, downloads to the portable terminal 10_k a core application for receiving various services on the service site provided by the management server 20, and stores the application into the memory 102. Then, for example, the processor 101 reads the core application from the memory 102 and expands it in the built-in memory to generate the core application processing unit 1011, and also generate a core account within the storage device 103. In an embodiment, the core application is embedded as firmware in the core application processing unit 1011 before hands.

The core application processing unit 1011 is an application that gathers various information of the user and computes the multidimensional vector of the user profile on the basis of the various information. In an embodiment, the online shopping and web browsing application processing unit 1012 includes code segments executable of the processor so that the application is configured to operate in cooperation with the core application processing unit 1011 and an online-shopping-related application that has been loaded onto the portable terminal of the user. When the user purchases some goods or services via the online-shopping-related application that has been loaded onto the portable terminal, information on the purchase is obtained, and the obtained purchase information is delivered to the core application processing unit 1011 on an as-needed basis or periodically. When the user browses websites via the web-browsing-related application that has been loaded onto the portable terminal, information on the web-browsing is obtained, and the obtained web-browsing information is delivered to the core application processing unit 1011 on an as-needed basis or periodically. Alternatively, the core application processing unit 1011 may be configured to periodically inquire of the online shopping and web browsing application.

The core account is an account that is associated with the portable terminal 10_k and allows for direct deposit or withdrawal of electronic money into/from the account or electronic payment through the account using the portable terminal 10_k, for example, upon receiving an instruction from the core application processing unit 1011. Further, the core account is also associated with a contracted account for payment of communication charges for the portable terminal or an account of a financial institution or a credit company owned (i.e., contracted) by the user by the core application processing unit 1011 so that each time the user deposits money or withdraws money using the portable terminal 10_k in a store or on the Internet and each time money is deposited into or withdrawn from the contracted account for payment of communication charges for the portable terminal or the account of the financial institution or the credit company owned (i.e., contracted) by the user regardless of whether the portable terminal 10_k is used by the user or not, information on such deposit or withdrawal of money is obtained via the core application processing unit 1011 on an as-needed basis or periodically so as to be stored into the core account.

In addition, the processor 101 reads the core application from the memory 102, and expands it in the built-in memory to generate the other various application processing units 1012 to 1019, and then sets storage areas (i.e., specific information storage areas) associated with the various application processing units within the storage device 103 in association with the core account, and stores various information obtained by the various application processing units into the storage areas.

### (ii) Step 602

The core application processing unit 1011 accesses one of the servers 90_1 to 90_n of the telecommunications companies 1 to n contracted by the user for the portable terminal 10_k, and at least one of the servers 80_1 to 80_n of the financial companies (i.e., contracted financial companies) 1 to n contracted by the user, either automatically or in response to an instruction of the user, and sets a link between the core account, the account of the user for payment of the communication charges, and the financial account. “To set a link” as referred to herein means performing association so as to be able to automatically obtain income and outgo information on the accounts and enable transfer (i.e., deposit and withdrawal) of money between the core account and such accounts. For example, when a target user deposits money or withdraws money into/from an account for which a link has been set, or when a third party transfers money to the account or withdraws money from the account, information on such deposit or withdrawal of money is sent to the portable terminal 10_k of the user one by one so that the information is stored into (written to) the core account by the core application processing unit 1011. Also, when the core application processing unit 1011 transfers money to the core account from an account for which a link has been set or transfers money to an account for which a link has been set from the core account in response to an instruction of the user, information on such deposit/withdrawal of money is stored into the core account by the core application processing unit 1011 one by one.

(iii) Step 603

The core application processing unit 1011 mutually associates the core application processing unit 1011 and the online shopping and web browsing application processing unit 1012, the exercise record application processing unit 1013, the SNS application processing unit 1014, the healthcare application processing unit 1015, the personal health record application processing unit 1016, the real estate management application processing unit 1017, the personnel information management application processing unit 1018, and the mapping application processing unit 1019 (which may also be referred to as various application processing units 1012 to 1019 hereafter) that have been generated in the portable terminal 10_k by the core application so that they operate in cooperation with one another. That is, the core application processing unit 1011 controls the operations of the various application processing units 1012 to 1019 so as to deliver information, which is obtained by the various application processing units 1012 to 1019, to the core application processing unit 1011 on an as-needed basis or periodically. “To operate in cooperation with one another” as referred to herein means that one operation triggers another operation. For example, when the core application processing unit 1011 obtains information from the various application processing units 1012 to 1019, the obtained information is stored into the core account set within the storage device 103, for example.

### (iv) Step 604

The core application processing unit 1011 obtains various information on the user (i.e., owner of the portable terminal 10_k) from the various application processing units 1012 to 1019 of the portable terminal 10_k, and stores the information into the core account set within the storage device 103. The core application processing unit 1011 operates in cooperation with the various application processing units 1012 to 1019 on an as-needed basis or periodically to obtain various information.

For example, the online shopping and web browsing application processing unit 1012 accesses an online-shopping-related application or web browsing related application that has been loaded onto the portable terminal, obtains information on purchase of goods/service of the user at an online store or information on web browsing by the user when he/she used the portable terminal 10_k (i.e., information on the types of purchased goods, the amount of money, date and time, stores of purchase as well as information on what the user viewed on the website), and stores the information into the core account set within the storage device 103 in association with the online shopping and web browsing application processing unit 1012. The core application processing unit 1011 obtains the information from the core account.

As noted above, the online shopping and web browsing application processing unit 1012 includes code segments executable of the processor so that the application is configured to operate in cooperation with the core application processing unit 1011 and an online-shopping-related application that has been loaded onto the portable terminal 10_k of the user (which means a portable terminal of the k-th user (where k=1 to n); hereinafter the same). When the user purchases some goods or services via the online-shopping-related application that has been loaded onto the portable terminal, information on the purchase is obtained, and the obtained purchase information is delivered to the core application processing unit 1011 on an as-needed basis or periodically. When the user browses websites via the web-browsing-related application that has been loaded onto the portable terminal, information on the web-browsing is obtained, and the obtained web-browsing information is delivered to the core application processing unit 1011 on an as-needed basis or periodically. Alternatively, the core application processing unit 1011 may be configured to periodically inquire of the online shopping and web browsing application.

The exercise record application processing unit 1013 obtains a record of exercise of the user, and stores the information into the core account set within the storage device 103 in association with the exercise record application processing unit 1013. The core application processing unit 1011 obtains the information from the core account. As described above, the exercise record application processing unit 1013 may, on the premise that the user performs exercise while holding the portable terminal 10_k, obtain data measured by various sensors (e.g., an accelerometer, a vibration sensor, a pulse sensor, an orientation sensor, and a gyro sensor) provided in the portable terminal 10_k, compute (estimate) the amount of exercise from the measured data, and record the data as a record of exercise. Alternatively, the amount of exercise may be estimated by obtaining information on the type of exercise and the duration of exercise from a plan of exercise of the user on a scheduler provided in the portable terminal 10_k or from a diary, for example. The core application processing unit 1011 generates a multidimensional vector as a whole of the exercise as well as each vector corresponding to each of the separate attributes of the above exercise records and sends and stores all the above in the core account set in the storage device 103.

The SNS application processing unit 1014 accesses an SNS (social networking service)-related application that has been loaded onto the portable terminal, obtains information on the friendship status of the user in the SNS when he/she used the portable terminal 10_k (e.g., information on the use frequency of the SNS, the number of friends, and communities to which the user belongs), and stores the information into the core account set within the storage device 103 in association with the SNS application processing unit 1014. The core application processing unit 1011 obtains the information from the core account, generates a multidimensional vector as a whole of the friendship status as well as each vector corresponding to each of the separate attributes of the above status, and sends and stores all the above in the core account set in the storage device 103.

The healthcare application processing unit 1015 accesses a healthcare-related application that has been loaded onto the portable terminal, obtains information on the healthcare of the user when he/she used the portable terminal 10_k (e.g., the body weight, the heart rate or pulses, and results of a medical checkup of the user), and stores the information into the core account set within the storage device 103 in association with the healthcare application processing unit 1015. The core application processing unit 1011 obtains the information from the core account, generates a multidimensional vector as a whole of the healthcare status as well as each vector corresponding to each of the separate attributes of the above healthcare status, and sends and stores all the above in the core account set in the storage device 103. Information on the heart rate or pulses of the user is obtained by the pulse sensor provided in the portable terminal 10_k, for example. In addition, information on the body weight or the results of the medical checkup of the user may be obtained by periodically inquiring of the user from the healthcare application processing unit 1015 (and receiving the information from the user), for example, or by accessing an external healthcare information management server (not illustrated in FIG. 1) from the healthcare application processing unit 1015 so as to obtain at least a part of information on the healthcare of the target user registered in the server.

The personal health record application processing unit 1016 accesses a medication-related application that has been loaded onto the portable terminal, obtains information on the medication state of the user when he/she used the portable terminal 10_k (e.g., the types of drugs, the frequency of medication, and effectiveness of the drugs), and the stores the information into the core account set within the storage device 103 in association with the personal health record application processing unit 1016. The core application processing unit 1011 obtains the information from the core account, generates a multidimensional vector as a whole of the health record above as well as each vector corresponding to each of the separate attributes of the above health records, and sends and stores all the above in the core account set in the storage device 103. For example, the personal health record application processing unit 1016 may also access an external medication data management server (not illustrated in FIG. 1) to obtain information, or the user may, upon purchasing a drug in a pharmacy, enter information on the purchased drug into the portable terminal 10_k so that the personal health record application processing unit 1016 can read the information. Alternatively, when the user purchases a drug in some shop, the personal health record application processing unit 1016 may communicate with the online shopping and web browsing application processing unit 1012 and obtain information on the purchased drug for management purposes.

The real estate management application processing unit 1017 obtains information on a real estate owned by the user (e.g., the type of the real estate, address, size, and the age of the real estate if it is a building), and stores the information into the core account set within the storage device 103 in association with the real estate management application processing unit 1017. The core application processing unit 1011 obtains the information from the core account, generates a multidimensional vector as a whole of the real estate status as well as each vector corresponding to each of the separate attributes of the above real estate status, and sends and stores all the above in the core account set in the storage device 103. Information on the real estate owned by the user may also be obtained by inquiring of the user from the real estate management application processing unit 1017 (and receiving the information from the user), for example, or by accessing an external real estate information management server (not illustrated in FIG. 1) from the real estate management application processing unit 1017 so as to obtain real estate information of the target user registered in the server.

The personnel information management application processing unit 1018 obtains the personnel information of the user (e.g., age, academic background, business career, annual income, and occupation), and stores the information into the core account set within the storage device 103 in association with the personnel information management application processing unit 1018. The core application processing unit 1011 obtains the information from the core account, generates a multidimensional vector as a whole of the personal information as well as each vector corresponding to each of the separate attributes of the above personal information, and sends and stores all the above in the core account set in the storage device 103. The personnel information of the user may also be obtained by inquiring of the user from the personnel information management application processing unit 1018 (and receiving the information from the user) periodically (e.g., once a year), for example. Further, the user may enter his/her personnel information by operating his/her portable terminal 10_k on an as-needed basis.

The mapping application processing unit 1019 obtains travel information of the user (e.g., travel date and time, travel route, place of stay, and duration of travel) by utilizing the GPS function of the portable terminal 10_k, and stores the information into the core account set within the storage device 103 in association with the mapping application processing unit 1019. The core application processing unit 1011 obtains the information from the core account, generates a multidimensional vector as a whole of the travel information as well as each vector corresponding to each of the separate attributes of the above travel information, and sends and stores all the above in the core account set in the storage device 103. Further, the mapping application processing unit 1019 estimates the residential zone of the user on the basis of the travel information, and accesses an external information providing server (not illustrated in FIG. 1) on the basis of the estimated residential zone so as to obtain information on the value of the living area, such as the land price of the estimated residential zone and the deviation values of schools in the zone, and then stores the information into the core account set within the storage device 103 in association with the mapping application processing unit 1019. The core application processing unit 1011 obtains the information from the core account, generates a multidimensional vector as a whole of the residential zone status as well as each vector corresponding to each of the separate attributes of the above residential zone status, and sends and stores all the above in the core account set in the storage device 103.

### (v) Step 605

The core application processing unit 1011 accesses one of the servers 90_1 to 90_n of the telecommunications companies and one of the servers 80_1 to 80_n of the credit card companies to obtain the debit account for payment of fees for the telecommunications company contracted by the user for the portable terminal 10_k as well as the income and outgo (i.e., deposited and withdrawn money) information (which includes balance information) on a financial (i.e., bank) account used (i.e., contracted) by the user and consumption information on a credit card contracted by the user (i.e., the date and time when the card was used, the amount of money, and the place where the card was used), and then stores the information into the core account set in the portable terminal 10_k. Although the present embodiment illustrates an example in which the core account is set within the storage device 103 of the portable terminal 10_k, the core account may also be set within a storage area dedicated to the user in a remote storage server (e.g., cloud service).

### (vi) Step 606

When the user directly deposits money into or withdraws money from the core account in a store or on the Internet using the portable terminal 10_k and/or each time money is transferred to the core account from an account for which a link has been set or money is transferred to an account for which a link has been set from the core account in response to an instruction of the user, the core application processing unit 1011 stores transaction information related to the deposit or withdrawal of money into the core account of the portable terminal on an as-needed basis or periodically.

(vii) Step 607

The core application processing unit 1011 obtains information on the deposit and withdrawal of money, consumption information, and the like of the user from the core account, and also obtains the aforementioned various information from the information storage areas of the core account associated with the various application processing units. The core application processing unit 1011 computes, as an evaluation value of the credit for the user, the multidimensional vector of the user credit status as whole as well as each vector corresponding to each of the separate attributes of the user credit on the basis of the obtained information. The multidimensional vector related to the user's credit status (including a set of vectors in the multidimensional vector space corresponding to each of the separate attributes of the user credit, hereinafter the same) is information representing the economic credit, living conditions, and the like of the user of the portable terminal 10_k. A predetermined or known credit rating method of a financial company may be used to generate the multidimensional vector. For example, a credit rating list including items that are necessary for the financial institution to determine the credit of users may be formed, or rating may be performed through classification on the basis of the incomes of the users or on the basis of financial information on local governments or distribution of schools in the living areas estimated from travel information. Specifically, for example, the more the balance of an account, the higher a rating that is given (i.e., the rating changes in a stepwise manner), and the more the deposit or withdrawal is executed periodically in a balanced manner, the higher a rating that is given. In addition, the health condition of the user is determined on the basis of the healthcare information and the medication information, and the better the health condition, the higher a rating that is given (e.g., 10th rate is given to those with normal blood pressure, zero rate is given to those with high blood pressure, and −10th rate is given to those with diabetes).

Each of the aforementioned financial information, such as income and outgo or balance of the account of the user, consumption information, friendship information, travel information, exercise information, medication information, healthcare information, own real estate information, personnel information, and the like is referred to as Credit-related Information, which is sent to and stored in the core account set in the storage device 103.

The Core Application Processing Unit 1011 retrieves the Credit-related Information from the core account and analyzes it into attributes. These attributes are then allocated into equivalent dimensions—that is tantamount to forming the multidimensional space encapsulating the Credit-related Information as a whole. The unit then sets a coordinate, namely a vector, of each of the attributes in each of the equivalent dimensions thus forming a multidimensional vector space encapsulating the Credit-related Information.

The Core Application Processing Unit 1011, at the same time as its processing the attributes and generating vectors assigns a different tag to each of the dimensions, the tag specifying the specific dimension, and creates a set of those tags. Each dimension is assigned a different tag to specify its specific attribute.

The Core Application Processing Unit 1011 generates a multidimensional vector as a tensor product in the multidimensional vector space with separately tagged dimensions. This information (multidimensional vector as well as the set of the vectors in the dimensions thus separately tagged) is stored in the storage device 103.

The tensor product is calculated using mathematical formulations such as determinant or product formula, utilizing tensor product operators and basis vectors stored in the storage device 103.

The core application processing unit 1011 may also assign a weight to each dimension of the multidimensional vector space encapsulating the Credit-related Information so as to adjust the final multidimensional vector representing the user credit by increasing or decreasing the evaluation rating for each attribute when integrating it. For example, the scalar of the vector representing the financial information may be multiplied by 1.5, and the same of the personnel information may be multiplied by 0.8 so that the resulting multidimensional vector may be integrated to reflect the total credit rating of the user.

(viii) Step 608

The Core Application Processing Unit 1011 sends the above multidimensional vector information, along with the set of separately tagged dimensions, representing the Credit-related Information, to the management server 20 via a communication network.

### <Details of Process Performed by Management Server>

FIG. 7 is a flowchart for illustrating a process executed by the management server 20. In this specification, description is made on the assumption that the subject that performs each step is the transaction processing unit 2011, the user information management unit 2012, or the affiliate company information management unit 2013. However, the subject may also be the processor 201 since the processor 201 executes such processing units.

### Step 701

The user information management unit 2012 receives information that identifies a portable terminal of a user and a multidimensional vector of the user profile (including a set of vectors in the multidimensional vector space corresponding to each of the separate attributes of the user profile, hereinafter the same) from one of the portable terminals 10_1 to 10_n, provides an identification ID of the user, and stores the ID into the storage device 203 in association with the information that identifies the portable terminal and the multidimensional vector of the user profile. The identification ID of the user being kept unchanged since the information that had identified the portable terminal was received, the user information management unit 2012 traces and manages the linkage between the identification ID of the user and the USER ID which keeps changed and issued in the portable terminal and coming into the management server 20 time to time, One of the portable terminals 10_1 to 10_n of the user issues a different USER ID time to time and sends it to the management server 20, where the changed USERID is shown on the service site provided by the management server 20. Though the different USER ID is shown time to time on the service site, the user information management unit 2012 links the thus changing USER ID to the unchanged identification ID of the user, so as to keep identifying the portable terminal of the user In addition, a personal page that is a user's dedicated page may be set when the identification ID of the user is issued, for example.

### (ii) Step 702

The user information management unit 2012 generates on the management server 20 a dedicated page (i.e., personal page) that can be viewed only by each user, for example.

The user information management unit 2012 discloses the USER ID as well as the similarity degree of the multidimensional vector of the goods/service profile to the same of each user profile on a company's dedicated page (described below) of the service site. At this time, the personal information of the user is not disclosed at all. Therefore, each company that accesses the company's dedicated page will offer various services or goods on the basis of only the similarity degree of the multidimensional vectors above. That is, for example, each of the financial service companies 1 to n determines a loan amount for a corresponding user on the basis of the similarity degree of the multidimensional vectors above. In addition, each of the online sales companies 1 to n determines a group of goods (i.e., at least one group of goods) that appears to be best for a corresponding user among the groups of goods handled on the basis of the similarity degree of the multidimensional vectors above. Further, each of the services-A-to-X-providing companies 1 to n determines a group of services (i.e., at least one group of services) that appears to be best for a corresponding user among the groups of services handled (e.g., medical services, such as complete medical checkups, human resource providing services, various rental services, outsourcing services, and online product services) on the basis of the similarity degree of the multidimensional vectors above. Further, each of the advertisement delivery companies 1 to n determines a group of advertisements (i.e., at least one group of advertisements) that appears to be best (or interesting) for a corresponding user on the basis of the similarity degree of the multidimensional vectors above.

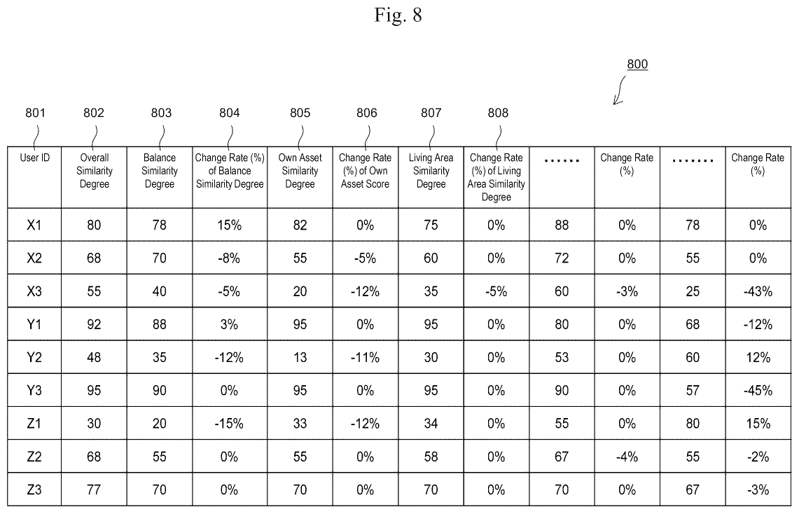

It should be noted that a display screen for the similarity degree of the multidimensional vectors that is disclosed will be described later (see FIG. 8).

(iii) Step 703

The affiliate company information management unit 2013 obtains information on the financial service companies 1 to n, the online sales companies 1 to n, the advertisement delivery companies 1 to n, and the services-A-to-X providing companies 1 to n (e.g., the address, telephone number, representative, the type of business, such as services or goods handled, and the business form of the company) and information on an offer of each company for each user, and stores the information into the storage device 203 together with the identification ID of each company. In addition, the affiliate company information management unit 2013 generates on the management server 20 a dedicated page (i.e., company's dedicated page) that can be viewed only by each company described above, and posts, on the page, the degree of the similarity calculated with the multidimensional vector of each user profile and the same of the goods or service profile generated by the processor 101 based on the information of the goods or service provided by the company. Further, the affiliate company information management unit 2013 reads information on a desired company from the storage device 203 as needed and sends the information to the transaction processing unit 2011.

### (iv) Step 704

The transaction processing unit 2011 receives, from each of the servers 30_1 to 30_n of the financial service companies 1 to n, the servers 40_1 to 40_n of the online sales companies 1 to n, the servers 50_1 to 50_n and 60_1 to 60_n of the services-A-to-X-providing companies 1 to n, and the servers 70_1 to 70_n of the advertisement delivery companies 1 to n, an offer determined to be provided to a target user by the company. Then, the transaction processing unit 2011 posts the offer for the user received from each company on the personal page of the user on the service site.

### (v) Step 705

The transaction processing unit 2011 notifies one of the portable terminals 10_1 to 10_n of the target user that there has been an offer(s) from each company. The user, upon receiving the notice, accesses his/her personal page on the service site using the portable terminal 10_k to check the offer from the company, and determines whether to accept the offer or not. The result of the determination is sent to the management server 20 from the portable terminal 10_k.

### (vi) Step 706

The transaction processing unit 2011 receives from one of the portable terminals 10_1 to 10_k of the target user a reply of the user to the offer(s) from each company.

(vii) Step 707

The transaction processing unit 2011 notifies the server of the relevant company that the reply of the user to the offer has been received. If the reply of the user is refusal, the process ends at this point. If the reply of the user is acceptance, the process proceeds to step 708.

(viii) Step 708

The transaction processing unit 2011 sends a contract form fill-in request to each of the portable terminal of the target user and the server of the target company to prompt the target user and the target company to enter information that is necessary to make a contract to purchase goods or services into the form on the service site (i.e., a page dedicated to the contract; for example, if the reply of the user is acceptance, each of the target user and the target company is provided with the right to access the page dedicated to the contract).

The user and the company enter necessary information into the contract form on the service site via the portable terminal of the user and the server of the company, respectively. After entering the necessary information, each of the user and the company places a check mark indicating that the form is filled out. If a check mark is not placed even after a predetermined period of time has elapsed, the transaction processing unit 2011 requests the portable terminal of the user and/or the server of the company to enter necessary information into the contract form (i.e., sends a reminder).

The necessary information to be entered by the user is limited as much as possible, for example, to confirmation of the contract provisions and confirmation of conclusion of the contract. User information that is necessary to fulfill a contract is, if there is portable terminal information identified by an identification ID of the user that has been already provided, sufficiently known from the debit account information for payment of communication charges of the user associated with the portable terminal information. Therefore, the company accesses the management server 20 from the server of the company after concluding a contract and obtains the portable terminal information of the user, and further accesses the server of the telecommunications company contracted by the user for the portable terminal and obtains the minimum user information that is necessary to fulfil the contract, such as the debit account information for payment of communication charges of the user. In the stage in which the contract form is filled in, the user is able to see only his/her own information, and the company is also able to see its own information. Thus, a contract can be concluded in the stage in which the personal information of the user is not disclosed to the company.

### (ix) Step 709

The transaction processing unit 2011 checks each of the contract forms filled out by the target user and the target company and determines if all of the necessary information has been entered and if correct information has been entered. Whether correct information has been entered or not is determined by, for example, checking the information entered into the contract form against information that has been obtained from each of the user and the company using a different method and at different timing (e.g., for the user, it is determined whether at least confirmed information on the portable terminal matches the debit account for payment of communication charges, and for the company, it is determined whether at least the license number matches the registered information).

### (x) Step 710

(x-1) Case where Loan Contract is Concluded Between User and Financial Company

For example, the transaction processing unit 2011 instructs the financial company to transfer a loan amount to the core account of the user. Then, upon confirming with the financial company that the transfer of the loan amount is complete and also confirming with the user that the loan amount has been received (for example, after receiving a notice of completion from each of the financial company and the user), the transaction processing unit 2011 may send information that identifies the portable terminal of the user, as security for the loan, to the server 30_k of the financial company so that the server 90_k (one of the servers 90_1 to 90_n) of the telecommunications company contracted by the user for the portable terminal is accessed via the financial company so as to obtain information on the debit account for payment of the communication charges of the user.

As another embodiment, the transaction processing unit 2011 of the management server 20 may be configured to once receive a loan amount from the financial company and confirm the amount and then send it to the core account of the user. In such a case, the transaction processing unit 2011 receives the loan amount sent from the server of the financial company and information related thereto (e.g., information on the borrower (i.e., the user ID of the borrower, the amount of money, and the contract date and time)), and stores them into the memory 202 or the storage device 203. Then, the transaction processing unit 2011 reads the information related to the loan amount from the memory 202 or the storage device 203, and confirms if the loan amount is correct (i.e., the same as the contracted amount). If the amount is determined to be correct, the transaction processing unit 2011 sends the loan amount to the portable terminal 10_k. The core application processing unit 1011 of the portable terminal 10_k stores the received loan amount into the core account generated within the storage device 103.

As described above, although the loan amount may be directly stored into the core account, the loan amount may also be transferred to the destination account of the financial institution for the core account (i.e., a financial institution contracted by the user) or the debit account of the user from which communication charges is withdrawn. In such a case, the transaction processing unit 2011 of the management server 20 manages a communication process related to transfer of the loan amount.

(x-2) Case where Goods Purchase Contract is Concluded Between User and Online Sales Company

The transaction processing unit 2011 instructs the online sales company to send the goods to the user and send a proof of shipment (e.g., an image of a slip of a parcel delivery service company) to the management server 20. Then, when a person in charge of the service site confirms that the delivery of the goods is complete, the transaction processing unit 2011 may send information that identifies the portable terminal of the user, as security for the payment for the goods, to the server 40_k of the online sales company so that the server of the telecommunications company contracted by the user for the portable terminal may be accessed via the online sales company so as to obtain the debit account information for payment of communication charges of the user (including the delivery address of the goods).

(x-3) Case where Service-Providing Contract (i.e., Purchase Contract) is Concluded Between User and Each of Services-A-to-X-Providing Companies

The transaction processing unit 2011 instructs ones of the service-A-to-X-providing companies to send data that proves the right to use the relevant service (e.g., an image or data of a membership card, membership number, and an access password) to the portable terminal 10_k of the user. When a person in charge of the service site confirms that the delivery of the document is complete (e.g., after receiving the notice of completion from the user), the transaction processing unit 2011 may send information that identifies the portable terminal of the user, as security for the payment for the contracted service, to the server 50_k of the service-providing company so that the server of the telecommunications company contracted by the user for the portable terminal may be accessed via the service-providing company so as to obtain the debit account information for payment of communication charges of the user.

### <Exemplary Configuration of the Multidimension Vectors' Similarity Degree Table of User>

FIG. 8 illustrates an exemplary configuration of an multidimension vectors' similarity degree table 800 of each user that is disclosed to each company on the company's dedicated page of the service site. As shown in the columns labeled 801-808+the table includes various similarity degree dimension tags.

The management server 20 receives the similarity degree of the multidimensional vector of the user profile to the same of the goods/service profile and updated information thereof from the portable terminals 10_1 to 10_n of the users on an as-needed basis or periodically and writes them into the company's dedicated page provided on the service site. If a new user is present, the user information management unit 2012 adds a field for the new user to the table in FIG. 8 and enters the multidimension vectors' similarity degree into the field. In addition, upon receiving an updated multidimension vectors' similarity degree of the existing user and the goods/service, the user information management unit 2012 updates the relevant similarity degree of the multidimensional vectors.

The multidimension vectors' similarity degree table 800 contains, as constituent items, at least a user ID 801 which keeps changed time to time in the portable terminal, the name of the goods/service to be provided by the company, and the similarity degree of the multidimensional vector of the user profile to the same of the goods/service profile, the latter of which has been automatically generated in the management server 20 with the profile of the goods/service described by the company in natural language (texts).

As described above, each company can access the company's dedicated page on the service site via the server of the company and see the multidimension vectors' similarity degree posted on the multidimension vectors' similarity degree table 800 of FIG. 8. Then, each company generates an offer (i.e., the aforementioned offer to provide loans, goods, or services) for a particular user and uploads the offer to the service site. Regarding loans, information as to whether each user wants to receive a loan or not may be posted on the company's dedicated page in advance (i.e., each user is able to send such information to the management server 20 on an as-needed basis), and a financial company may generate an offer for the user (i.e., the one who wants to receive a loan) in response to the information and upload the offer to the page.

In summary, the system comprises the following components: an intermediate management server (implemented on one of more physical or virtual servers), a plurality of service provider/content providers servers and a plurality of portable user terminals.

The intermediate (management) server stores the multidimensional user profile vector, the dimension tag set and user ID generated by the portable terminal of the user and sent to the management server.

The external server of the service provider company connects to the management server via a communication line and puts into the management server the target attributes, described in natural language, comprising his target user profile presumed to match with the profile of the goods/service planned to be offered

An AI function in the management server automatically generates the multidimensional vector representing the target user profile, picks up, from the user profile already sent from the portable terminal to and stored in the management server, the multidimensional vector of the user profile in the multidimensional vector space comprised with the set of the tagged dimensions equivalent to the set of the attributes of the target user reflecting the profile of the goods/service, finds out the similarity degree of the multidimensional vector representing the user profile from the portable terminal to the multidimensional vector representing the target user profile from the company server, and sends it to the company server via the communication line

The portable terminals generate a multidimensional vector (as a tensor product) of the user profile therein, puts a tag to the Basis of each of the dimensions consisting of the multidimensional vector as a decomposition element of the multidimensional vector therein, generates a user ID at any time therein, and transmits the multidimensional vector of the user profile, the above dimension tag set and the user ID to the management server.

Finally, it should be appreciated that the process and technology described herein may be implemented substantially by any suitable combination of components without being related to a specific device. Further, various types of general-purpose devices can be used in accordance with the teaching described herein. It may be found to be advantageous to construct a dedicated device to execute the steps of the method described herein. In addition, various inventions can be formed by appropriately combining a plurality of components disclosed in the embodiment. For example, some of the components shown in the embodiment may be removed. Further, the components in different embodiments may be appropriately combined. Although the present embodiment has been described with reference to specific examples, such examples are shown not for limiting purposes but for explanation purposes in all aspects. Those skilled in the art may appreciate that there are a number of combinations of hardware, software, and firmware that are suitable for implementing the present embodiment. For example, the software described herein may be implemented by an assembler or a wide range of programs or script languages such as C/C++, perl, Shell, PHP, or Java (registered trademark).

Further, in the aforementioned embodiments, the control lines and information lines represent those that are considered to be necessary for description purposes, and do not necessarily represent all control lines and information lines for a product. In practice, almost all structures may be mutually connected.

In summary, both profile marketing and targeted advertising processes ensure user anonymity while allowing for effective marketing strategies based on user attributes. It should be noted that the present disclosure is not limited to the aforementioned embodiments, and includes various modified examples. For example, although the aforementioned embodiments have been described in detail to clearly illustrate the present disclosure, the present disclosure need not include all of the structures described in the embodiments.

### Service-Providing System

10_1 to 10_n (10_k) Portable terminals
20 Management server
30_1 to 30_n Servers of loan companies
40_1 to 40_n Servers of online sales companies
50_1 to 50_n Servers of service-A-providing companies
60_1 to 60_n Servers of service-Z-providing companies
70_1 to 70_n Servers of advertisement delivery companies
80_1 to 80_n Servers of contracted financial companies
90_1 to 90_n Servers of telecommunications companies
100 Network

1, An intermediate management server for anonymized user profiling and content delivery in a system comprising a plurality of user terminals, each associated with a user and each user terminal equipped with computing and communication equipment including a processor, memory and code segments configured to collect user data and generate multidimensional user profile vectors and dimension tags and transmitting the multidimensional user profile vectors and dimension tags in association with a unique USERID; a plurality of service providers seeking to provide content to target users with select attributes, and configured to submit Market Persona requests comprising human-readable text describing a set of Market Persona attributes; the intermediate management server for anonymized user profiling and content delivery comprising computing equipment including a processor, memory, storage device, input device, output device, communication device and a data bus, the management server further comprising code segments executable in the processor to provide:
a data reception module for receiving user data from said portable terminals, the user data including multidimensional user profile vectors and dimension tags and a unique USERID;
a data reception module for receiving Market Persona requests from said service providers, the requests comprising human-readable text describing the goods/service/target profiles for content;
a multidimensional Market Persona vector generation unit for creating a multidimensional vector representing a Market Persona based on the text received from the service provider, with a set of the tagged dimensions equivalent to the set of the attributes of the target user reflecting the Market Persona;
a comparison module for comparing said multidimensional Market Persona vector to multidimensional user profile vectors to identify similarities and patterns;
a content delivery facilitation module for delivering content to matched target users based on said comparisons, without disclosing user identities or content providers.

2. The system of claim 1, wherein the content provided by the service providers comprises advertisements for goods or services.

3. The system of claim 1, wherein the data reception module for receiving user data from said portable terminals receives an updated multidimensional user profile vector at periodic times.

4. The system of claim 1, wherein the data reception module for receiving user data from said portable terminals receives an updated multidimensional user profile vector when a change is made to the multidimensional user profile vector.

5. The system of claim 1, wherein the data reception module for receiving user data from said portable terminals receives an updated multidimensional user profile vector when a change made to the multidimensional user profile vector exceeds a predetermined threshold.

6. The system of claim 1, wherein the intermediate management server sends a report to the service provider reporting the number of users determined to be a match in the comparison of said multidimensional Market Persona vector to multidimensional user profile vectors.

7. The system of claim 6, wherein the report further includes the USERID of users determined to be a match.

8. The system of claim 7, wherein the report further includes a degree of matching for users determined to be a match.

9. A non-transitory computer readable media including program instructions executable on a digital processor for use in a system equipped to communicate with a plurality of user portable terminals, each associated with a USERID and configured to collect user data; and configured to communicate with a plurality of service providers seeking to communicate with users having select attributes, the program instructions comprising:
code sections obtaining user data from said portable terminals in the form of multidimensional user profile vectors, dimension tags and a unique USERID;
code sections storing the multidimensional user profile vectors and dimension tags in association with the USERID
code sections obtaining requests from said service providers, comprising human-readable text describing a Market Persona for content;
code sections that generate a multidimensional Market Persona vector representing the Market Persona based on said human readable text, with a set of the tagged dimensions equivalent to the set of the attributes of the target user reflecting the Market Persona;
code sections that compare said multidimensional Market Persona vector to multidimensional user profile vectors associated to identify similarities and patterns and identify matched target users;
code sections that facilitate the delivery of content to matched target users based on said comparisons, without disclosing user identities or content providers.

10. A system for targeted delivery of content comprising the following components: a plurality of portable user terminals, an intermediate management server and a plurality of content provider servers in communication with the intermediate servers, wherein
the plurality of portable user terminals generate a multidimensional user profile vector as a tensor product of the user profile therein, generate a dimension tag set of the tags, each of which represents the decomposition element of the multidimensional user profile vector therein, generate a unique user ID to the multidimensional user profile vector and the dimension tag set, and transmit the multidimensional user profile vector, the dimension tag set, and the user ID to the intermediate management server;
the intermediate management server receives and stores the multidimensional user profile vector, the dimension tag set and the user ID;
the external server of the content provider company communicates with the intermediate management server via a communication line and transmits Market Persona attributes, described in natural language, comprising a target profile presumed to match with the profile of the goods/service planned to be offered;
an AI function in the intermediate management server automatically generates a multidimensional vector representing the Market Persona, picks up, from the user profile already sent from the portable terminal to and stored in the intermediate management server, the multidimensional vector of the user profile in the multidimensional vector space comprised with the set of the tagged dimensions equivalent to the set of the attributes of the target user reflecting the Market Persona, finds out the similarity degree of the multidimensional vector representing the user profile from the portable terminal to the multidimensional vector representing the Market Persona from the content provider server, and prepares the intermediate management server to send it to the content provider server via the communication line;
the external server of the content provider company transmits to the intermediate management server via a communication line i) the content which the company wants to send to the target who is selected in the process of comparison of the selected multidimensional user profile vectors and the generated multidimensional Market Persona vector, and ii) the user ID which the company finds in the intermediate management server as the ID of his target;
the intermediate management server identifies the user ID and its contact information, which are for the target of the content provider company, and transmits the content provided by the company to the target via a communication line.

11. An intermediate management server for anonymized user profiling and content delivery for use in a system that includes a plurality of user terminals and a plurality of service providers seeking to provide content to target users with select attributes, wherein the plurality of user terminals are each associated with a user and equipped with computing and communication equipment including a processor, memory, and code segments configured to collect user data; generate multidimensional user profile vectors, where each vector includes dimensions tagged, and transmit the multidimensional user profile vectors and associated dimension tags, along with a unique USERID, to the intermediate management server, and the plurality of service providers are equipped with computing and communication equipment including a processor, memory, and code segments configured to submit Market Persona requests comprising human-readable text describing a set of Market Persona attributes, which may include desired customer demographics, psychographics, behaviors, and specific interests;
the intermediate management server for anonymized user profiling and content delivery, comprising computing equipment including a processor, memory, storage device, input device, output device, communication device, and a data bus, and further comprising code segments executable in the processor and configured to:
Receive Market Persona requests from service providers, wherein the Market Persona requests include detailed human-readable text descriptions of desired Market Persona attributes;
Converting the received Market Persona attributes into a multidimensional Market Persona vector, where each dimension is tagged with metadata corresponding to specific attributes such as age, gender, interests, purchasing behavior, and other relevant factors;
Receive the multidimensional user profile vectors and dimension tags from user terminals, each vector associated with a unique USERID, store the multidimensional Market Persona vectors and user profile vectors in a database;
Match the multidimensional Market Persona vector against the stored multidimensional user profile vectors to identify alignment between the Market Persona attributes and user profile attributes;
Calculate a matching degree for each user profile vector to determine the deviation in alignment with the Market Persona vector, where the matching degree indicates how closely a user's profile matches the desired attributes specified by the service provider;
Transmitting data to the service provider, including at least one of the total number of users matching the Market Persona attributes; the USERIDs of the matching users; and the matching degree for each user, indicating the deviation in alignment with the Market Persona attributes.

12. The intermediate management server of claim 11, further comprising utilizing natural language processing (NLP) algorithms to convert human-readable Market Persona attributes into structured multidimensional vectors.

13. The intermediate management server of claim 11, further comprising storing user profile vectors and Market Persona vectors in a distributed database system to facilitate efficient access and processing.

14. The intermediate management server of claim 11, wherein the server is implemented using multiple server devices and can be hosted on cloud platforms such as AWS.
